(19) United States
(12) Patent Application Publication
(10) Pub. No.: US 2026/0179619 A1
(43) Pub. Date: Jun. 25, 2026

(54) SYSTEMS AND METHOD FOR AUTOMATED STROKE DETECTION

(71) Applicant: Neuronics Medical Inc., Los Angeles, CA (US)

(72) Inventors: Radoslav Raychev, Los Angeles, CA (US); James Shanahan, Los Angeles, CA (US); Valeriy Nenov, Los Angeles, CA (US)

(21) Appl. No.: 19/531,526

(22) Filed: Feb. 5, 2026

Related U.S. Application Data
(63) Continuation-in-part of application No. 19/101,674.
(60) Provisional application No. 63/371,824, filed on Aug. 18, 2022.
(60) Provisional application No. 63/754,422, filed on Feb. 5, 2025.
(60) Provisional application No. 63/857,678, filed on Aug. 5, 2025.

(51) Int. Cl. G10L 15/32

(52) U.S. Cl. CPC G10L 15/32

(57) ABSTRACT

Systems and methods are provided for detecting a stroke. Input data is captured from a plurality of sensors and transformed based on artifacts associated with an artificial intelligence or machine learning (AI/ML) model. The AI/ML mode is trained using a data set that includes at least one of facial asymmetry data, speech data, and motion data associated with stroke symptoms. Based on the transformed input data, the AI/ML model determines a stroke condition probability.

### CROSS-REFERENCE TO RELATED APPLICATION(S)

This application claims the benefit of U.S. Provisional Patent Application No. 63/754,422, filed Feb. 5, 2025 and U.S. Provisional Patent Application No. 63/857,678, filed Aug. 5, 2025. This application is also a continuation-in-part (CIP) of U.S. patent application Ser. No. 19/101,674, filed Feb. 6, 2025, which is a national stage application under 35 U.S.C. § 371 of International Patent Application No. PCT/US2023/072519, filed Aug. 18, 2023, which claims the benefit of U.S. Provisional Patent Application No. 63/371,824, filed Aug. 18, 2022. Each of the foregoing applications is hereby incorporated by reference herein in its entirety.

### BACKGROUND

A stroke refers to a sudden interruption of blood supply to the brain, leading to the loss of brain function. It can be caused by a blockage in a blood vessel (ischemic stroke) or by the rupture of a blood vessel (hemorrhagic stroke). Strokes can have severe consequences, including physical impairments, cognitive deficits, and even death. The symptoms of a stroke can vary depending on the specific type of stroke (ischemic or hemorrhagic) and the area of the brain affected. Common symptoms of a stroke include, for example: sudden numbness or weakness in the face, arm, or leg, typically on one side of the body; trouble speaking or understanding speech; confusion or difficulty comprehending simple instructions; trouble seeing in one or both eyes, such as blurry vision or loss of vision; sudden severe headache with no known cause; trouble with coordination, dizziness, or loss of balance; and/or difficulty walking or a sudden loss of balance or coordination. Such symptoms can appear suddenly and without warning.

A stroke may be reversible if caught and treated early. However, less than 5% of all acute stroke patients are treated in the “golden” three hour time window due to delays in diagnosis and poor stroke recognition among caregivers, patients, and families.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an overview of an example process flow for automating a FAST protocol for detection of acute stroke, according to certain embodiments.

FIG. 2 illustrates a modular overview of an example process flow for automating the FAST protocol for detection of acute stroke, according to certain embodiments.

FIG. 3 illustrates an example processing flow of a pipeline for processing facial videos, according to one embodiment.

FIG. 4A and FIG. 4B illustrate example output images of a patients' faces overlaid with facial landmark points, asymmetry indicia, and other indicia, according to certain embodiments.

FIG. 5A, FIG. 5B, FIG. 5C, FIG. 5D, FIG. 5E, FIG. 5F, FIG. 5G, and FIG. 5H are annotated images of a patient's face used to define different classes of facial landmarks, according to one embodiment.

FIG. 6A illustrates a wearable device that may be worn by a patient, according to certain embodiments.

FIG. 6B illustrates an example display of a mobile phone used to instruct the use of, and collect data from, the wearable device shown in FIG. 6A, according to certain embodiments.

FIG. 7 illustrates an example processing flow of a pipeline for detecting arm weakness by analyzing various motion specific metrics, according to one embodiment.

FIG. 8 illustrates filtered and normalized acceleration signals, angular velocity signals, and magnetic field signals processed, according to certain embodiments.

FIG. 9A illustrates example acceleration signals processed according to certain embodiments.

FIG. 9B illustrates example angular velocity signals processed according to certain embodiments.

FIG. 10A illustrates example acceleration signals and angular velocity signals processed according to certain embodiments for an arm of a healthy person.

FIG. 10B illustrates example acceleration signals and angular velocity signals processed according to certain embodiments for an arm with subtle weakness.

FIG. 10C illustrates example acceleration signals and angular velocity signals processed according to certain embodiments described for an arm with moderate weakness.

FIG. 11 illustrates an example processing flow of an audio processing pipeline according to one embodiment.

FIG. 12 illustrates an example display of a mobile phone used to instruct a gaze test and display the results, according to certain embodiments.

FIG. 13 is a block diagram illustrating a transformer lip-to-text model architecture, according to one embodiment.

FIG. 14 illustrates an example of a FAST AI online inference pipeline wherein a current video and baseline video may be compared against each other, according to one embodiment.

FIG. 15 illustrates a flowchart of a method for stroke detection, according to embodiments herein.

FIG. 16 illustrates a flowchart of a method for stroke detection, according to embodiments herein.

FIG. 17 illustrates a flowchart of a method for training an AI/ML model for stroke detection, according to embodiments herein.

FIG. 18 illustrates a flowchart of a method 1800 for training an AI/ML model for stroke detection, according to embodiments herein.

FIG. 19 is a schematic illustration of a computing system arranged in accordance with examples of the present disclosure.

### DETAILED DESCRIPTION

### I. Approach Overview

Embodiments disclosed herein provide an artificial intelligence (AI)-enabled automated solution for clinical diagnosis of stroke. Such embodiments may help increase stroke treatment by improving acute recognition and diagnosis.

Certain embodiments use the FAST (Face, Arm, Speech, Time to call 911) and/or BE FAST (Balance, Eyes, Face, Arms, Speech, Time to call 911) paradigms for acute stroke recognition. The FAST and/or BE FAST paradigms may also be referred to herein as approaches or protocols. The FAST approach is a simple and effective method for quickly identifying the signs of a stroke. The FAST approach includes looking for face drooping, which may include unevenness or drooping on one side of the face. A user of the approach (e.g., medical personnel, a family member, or a friend) may, for example, ask the person to smile and observe if one side of the face does not move as well as the other. The FAST approach further checks for arm weakness. For example, the user may ask the person to raise both arms. If one arm drifts downward or cannot be held up compared to the other, it may indicate arm weakness. The FAST approach further checks for speech difficulties, wherein the user listens carefully to the person's speech. Slurred speech, difficulty in finding words, or the person being unable to speak or understand speech are potential signs of a stroke. In addition, or in other embodiments, other approaches or protocols may also be used, such as the National Institutes of Health Stroke Scale (NIHSS), which is a standardized neurological exam used to quantify stroke severity.

Certain embodiments disclosed herein use the FAST approach in a stroke detection system, such as an automated application executed by a smart phone, for detection of acute stroke signs using artificial intelligence (AI) and/or machine learning (ML) algorithms for recognition of facial asymmetry, arm weakness, and speech changes. The AI/ML algorithms may also base detection of the stroke on other characteristics such as balance or eye movements (e.g., gaze). If the stroke detection system detects or predicts that a person has any symptoms (e.g., facial asymmetry, arm weakness, slurred speech, imbalance, abnormal gaze movements), the stroke detection system may automatically call emergency services. To enable automatic assessment of the core FAST components, certain embodiments may use multi-modality machine learning methods that may be designed with particular tasks in mind.

Certain embodiments herein use a mobile application (app) on a commercially available mobile device such as a mobile phone, tablet, or laptop to collect video, arm movement, and voice data from the patient. These data are analyzed independently using machine learning algorithms, and the results are displayed to a healthcare professional or other user of the mobile device. This information can be used to determine the appropriate next steps for the patient within the clinical workflow.

Table 1 provides examples of various disclosed data modes with corresponding patient data that may be collected and analyzed, according to certain embodiments.

TABLE 1
Collected Patient Data and Data Analysis

| Data Mode | Description | Data Analysis |
|---|---|---|
| Video-based | The patient is instructed to perform | FAST AI app uses |
| detection of facial | specific facial movements such as | augmented reality (AR) |
| asymmetry | open and close eyes, look left and | based libraries for face |
| | right while a video records their face. | tracking and analyzing eye |
| | | movement and facial feature |
| | | asymmetries. Logs the |
| | | results and displays them as |
| | | a face mask overlay and |
| | | numerically as a percent |
| | | deviation from a normal |
| | | state. |
| Sensor-based arm | The patient is asked to raise and keep | FAST AI app records motion |
| movement | each arm in the air in a particular | sensor data, determines the |
| assessment | position (e.g., for 10 seconds) while | sensor attitude in real-time |
| | holding the phone. Alternatively, the | by fusing the accelerometer |
| | data can be collected through | and gyroscope data. Uses |
| | external wearable sensor placed on | empirically established |
| | the patient's wrist. The sensor is | thresholds and under-the- |
| | wirelessly connected to the | curve calculations to |
| | smartphone. | determine arm weakness. |
| Audio-based slurred | The patient reads several words | FAST AI app records the AV |
| speech/dysarthria | aloud while high-quality audio is | session and uses enhanced |
| detection | recorded along with the video in a | speech recognition sound |
| | synchronized audio/visual (AV) | power analysis to |
| | session. | algorithmically determine the |
| | | presence of slurred speech. |
| | | The results are displayed |
| | | graphically and numerically. |
| Video-based arm | The patient is instructed to raise and | FAST AI uses computer |
| movement | hold each arm in a specific position | vision to capture and analyze |
| assessment | (e.g., for 10 seconds) while the | arm motion by extracting key |
| | clinician/user records the activity | points, calculating movement |
| | using the smartphone camera. | metrics, and generating |
| | | feedback for evaluating |
| | | motor function |
| Video-enabled | The patient is instructed to move | FAST AI analyzes the |
| detection of gaze | their eyes in different directions by | trajectory, speed, and |
| abnormalities | following a cursor or other target | smoothness of the eye |
| | moving across the screen. | movements to detect any |
| | | abnormalities. |
| Audio-enabled | The patient describes a standardized | FAST AI analysis involves |
| aphasia model | NIHSS picture, and their response is | an initial coherence check |
| | transcribed to text and split into | and categorizing each word |
| | individual words. The audio file is | by type. The ML model |
| | recorded and analyzed. | analyzes a patient's verbal |
| | | description by processing |
| | | their speech with natural |
| | | language processing (NLP) |
| | | algorithms to assess fluency, |
| | | accuracy, and coherence, |
| | | identifying signs of |
| | | expressive or receptive |
| | | aphasia. |

In certain embodiments, a FAST AI system includes a FAST AI clinical mobile application, a FAST AI service application, and a FAST AI administration application. The FAST AI clinical mobile application collects patient data (e.g., facial video, motion data, and voice data) and shares the collected data with the FAST AI service application. The FAST AI service application may use cloud-based machine learning algorithms to analyze the data to detect facial asymmetry, arm weakness, and slurred speech. The FAST AI administration application may be used for user administration and preparation of AI training datasets.

Patients who experience a stroke or transient ischemic attack (TIA) may require long-term monitoring for successive episodes. Rather than requiring frequent office visits for evaluation, embodiments disclosed herein can be used for remote patient monitoring. This would lessen the burden on patients and clinicians, particularly in the first thirty days post-hospital discharge when the recurrent stroke risk is highest.

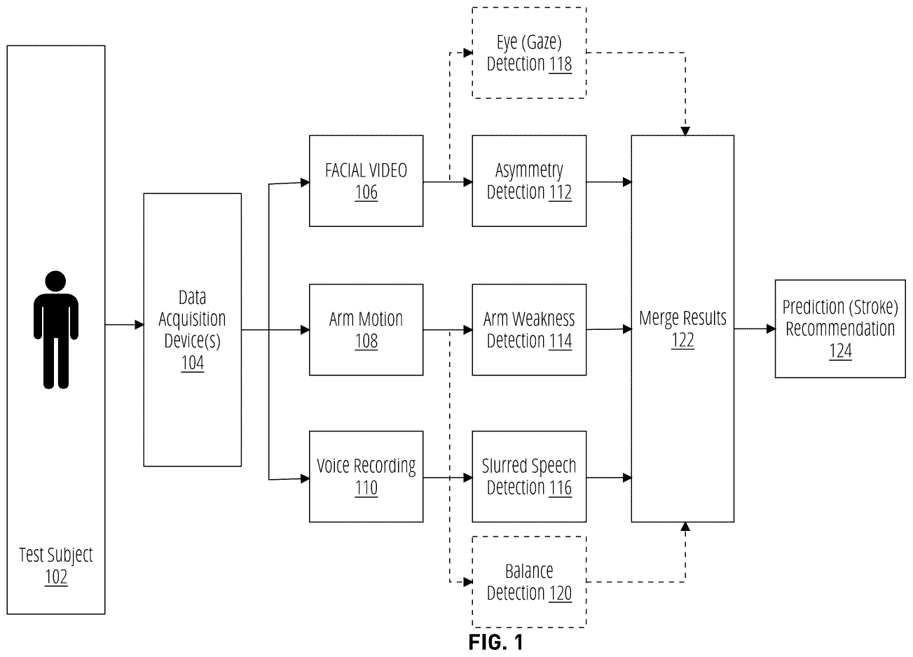

At a high level, FIG. 1 illustrates an overview of an example process flow for automating a FAST protocol for detection of acute stroke according to certain embodiments. A test subject 102 may interface with a data acquisition device or data acquisition devices 104. The test subject 102 may also be referred to as a subject, a person, or a patient. The data acquisition devices 104 may be, for example, a mobile phone (e.g., smart phone), tablet, or laptop computer configured to collect various types of data. For example, the data acquisition devices 104 may collect facial video data 106 of the test subject 102, arm motion data 108 corresponding to one or more arm motion measurements of the test subject 102, and/or voice recording data 110 corresponding to speech by the test subject 102. These three data modalities may be processed independently and then merged together to generate a diagnosis of a stroke.

As shown in FIG. 1, the automation of the FAST protocol may be achieved by independently processing three or more data modalities used for the assessment of the test subject 102. For example, the facial video data 106 may be processed for asymmetry detection 112, wherein the test subject 102 is asked to perform certain facial movements (e.g., as prescribed by the FAST protocol) while a video of their face is being recorded. The arm motion data 108 may be processed for arm weakness detection 114, wherein the test subject 102 is asked to raise and keep their hands in a particular position (e.g., as prescribed by the FAST protocol) while they hold a device capable of recording acceleration, rate of rotation and strength of the ambient magnetic field in three dimensions. In other embodiments, the motion may be determined from video data. The voice recording data 110 may be processed for slurred speech detection 116, wherein the test subject 102 is asked to read aloud several words (e.g., as prescribed by the FAST protocol) while high quality audio is being recorded. In addition, or in other embodiments, the facial video data 106 may be processed for eye (gaze) detection 118 and/or the arm motion data 108 or other motion data may be processed for balance detection 120. Each of the asymmetry detection 112, arm weakness detection 114, slurred speech detection 116, eye (gaze) detection 118, and balance detection 120 may comprise a separate AI/ML model that is independently trained, or a single AI/ML model that is trained based on merged 122 results.

The information used for the data modalities may be gathered during a self-assessment performed using the stroke detection system by the test subject 102 themselves or by a third party, such as a paramedic or triaging personnel.

In order for the embodiments to be as flexible as possible with respect to the hardware device(s) used for the acquisition of the data, each data modality may be processed independently of the others and the results may be merged 122 to generate an output 124 including a prediction (e.g., of a stroke) or recommendation (e.g., to seek emergency medical treatment). This may enable a much more extensive analysis of the performance of the underlying machine learning models that can be performed over each of the available data modalities independently.

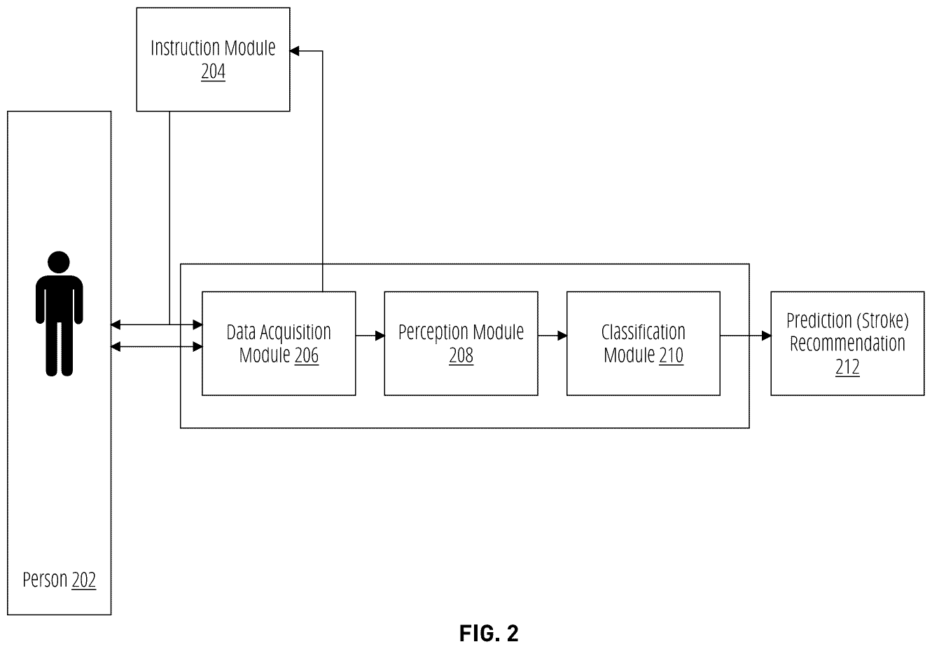

FIG. 2 illustrates a modular overview of an example process flow for automating the FAST protocol for detection of acute stroke, according to certain embodiments. An instruction module 204 may instruct a person 202 who is or may be experiencing a stroke, or may have experienced a stroke in the past, in a sequential or parallel manner to look at a device (e.g., a camera or a camera of a mobile phone), perform arm exercises, and perform some speech acts. A data acquisition module 206 captures data about the person 202 from various sensors such as a color camera (e.g., a red-green-blue (RGB) or an RGB-depth (RGBD) camera), an audio capture device, and motion sensors such as an accelerometer, magnetometer, and/or gyroscope. A perception module 208 may summarize (i.e., transform) the captured data into high-level artifacts such as pose or location points for a face, an arm motion, and speech that is summarized as Mel Frequency Cepstral Coefficients (MFCC). A classification module 210 accepts as input the raw sensor data and the summaries from the perception module 208, and may assign a stroke classification label and a corresponding probability. The data acquired by the data acquisition module 206 may include video of the person 202, arm motion measurements, and/or voice recording. These three data modalities may be processed independently and then merged together in order to generate a diagnosis of stroke. An output 212 may include a prediction (e.g., stroke) and/or a recommendation (e.g., to seek emergency medical treatment).

### II. Detecting Facial Asymmetry

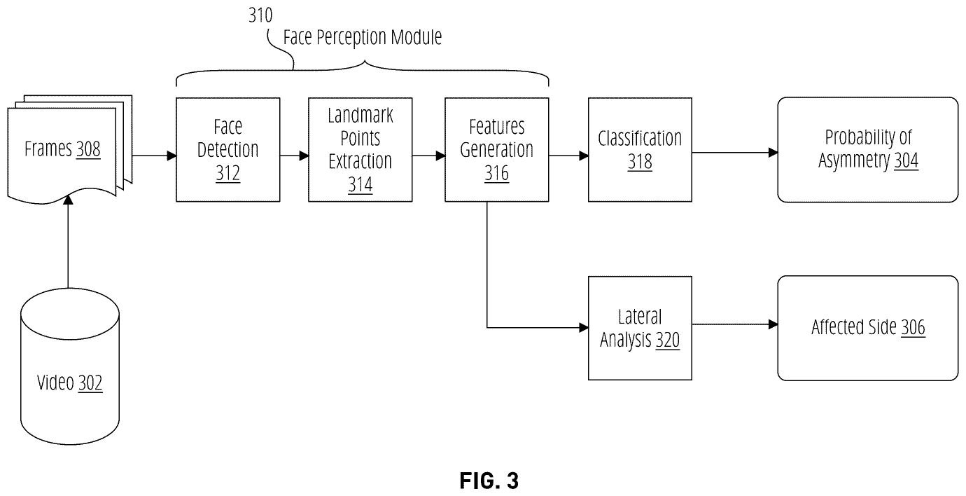

FIG. 3 illustrates an example processing flow of a pipeline for processing facial videos according to one embodiment. For a single test subject video 302, the output of the pipeline may include an estimated probability 304 of facial asymmetry being present, an estimated uncertainty (not shown) of the prediction, and an indication of an affected side 306 of the face if asymmetry is present. In addition, or in other embodiments, the output also includes an indication that differentiates between stroke-related facial asymmetry and Bell's palsy-related facial asymmetry.

The pipeline for detecting facial asymmetry may perform multiple processing steps, as illustrated in FIG. 3, to make a prediction if facial asymmetry is present in the video 302. In certain embodiments, the perception module 208 shown in FIG. 2 includes a face perception module 310, as shown in the pipeline of FIG. 3. The perception module 208 includes a face perception module 310 for face detection, a facial landmark detector 314 for landmark points extraction, and a features generator 316 for features generation.

### A. Frame Analysis and Frame Detection

The processing flow starts by taking in a video V (shown as video 302) that is split into frames F_{1, . . . , N} (shown as frames 308). Each frame Fᵢ may then processed by the face detector 312 that outputs bounding boxes b_{1, . . . , M}_{ᵢ}, where Mᵢ is the number of faces detected in frame Fᵢ. The largest detected face in a frame may be found by applying non-maximal suppression based on the bounding box area such that Bᵢ=argmax ({area (bᵢ)|bᵢ∈b_{1, . . . , M}_{ᵢ}}). As a result, there may be N bounding boxes denoted as B_{1, . . . , N}. Each bounding box is then passed through the facial landmark detector 314 resulting in a set Lᵢ={l_{i,1}, l_{i,2}, . . . , l_{i,K}} where l_{i,j}∈[0; 1]² is a two dimensional (2D) location with normalized coordinates between 0 and 1 with respect to Bᵢ and K is the number of detected facial landmark points in frame Fᵢ.

### B. Landmark Point Analysis

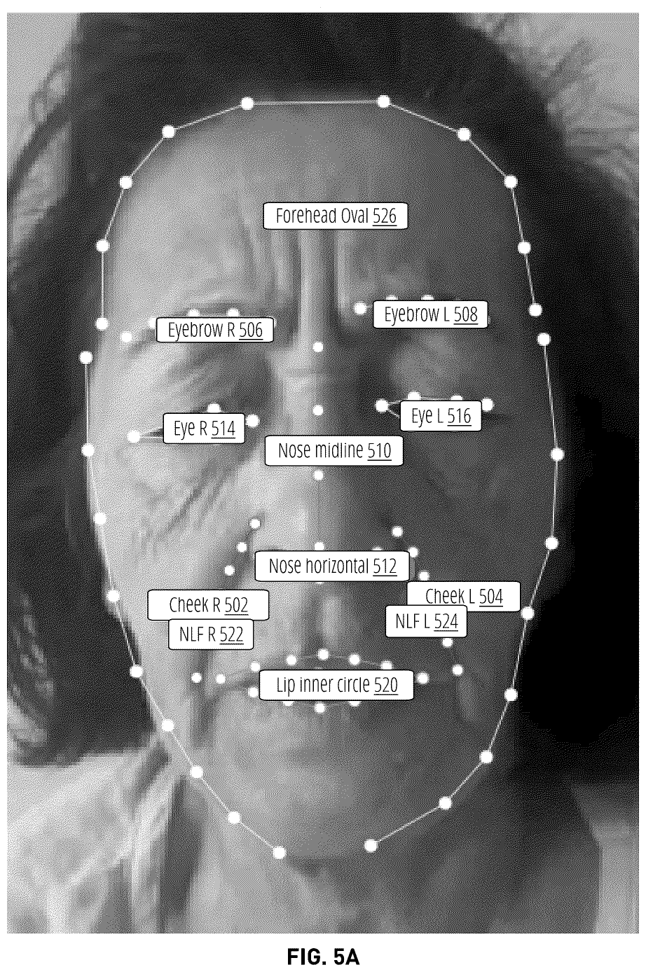

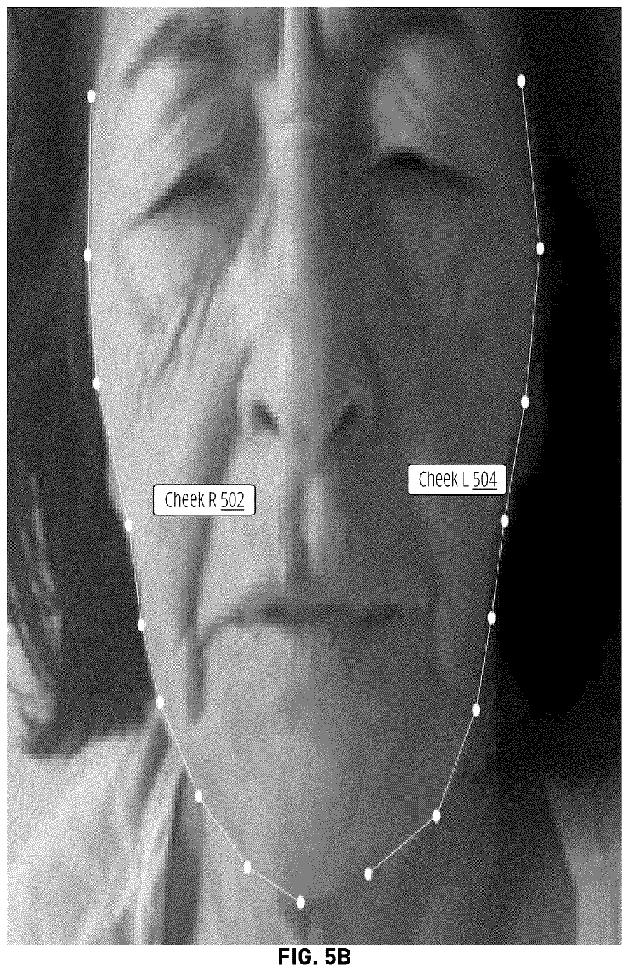

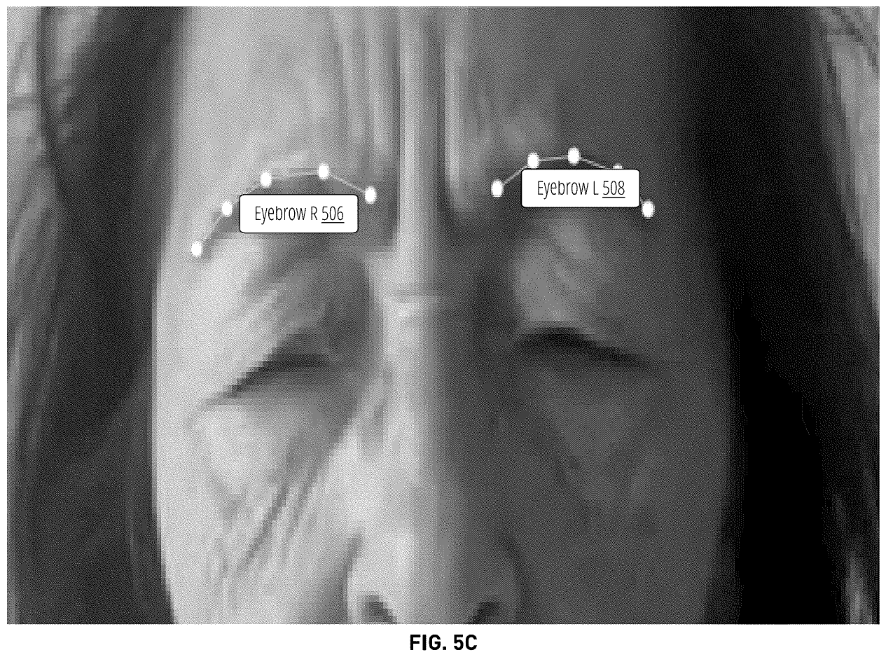

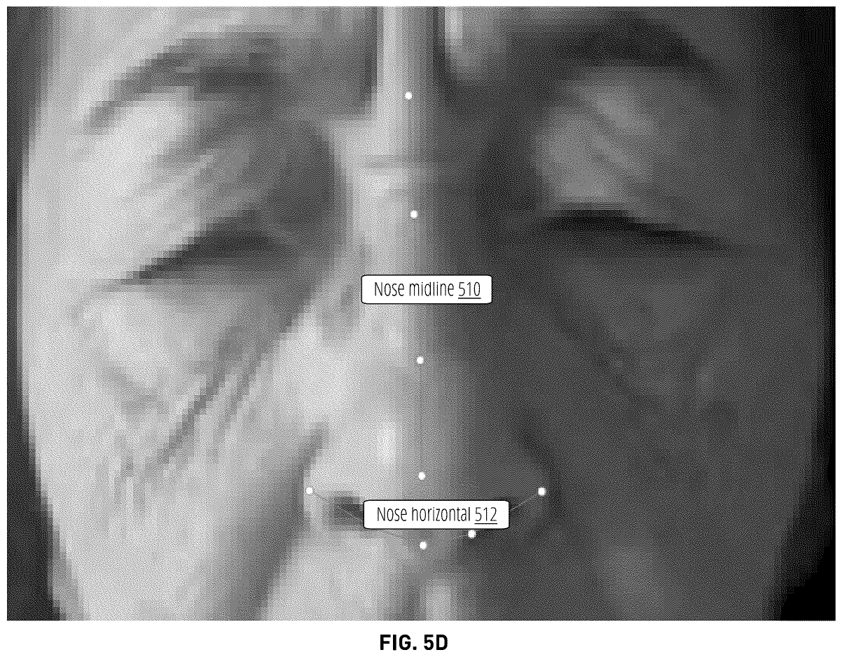

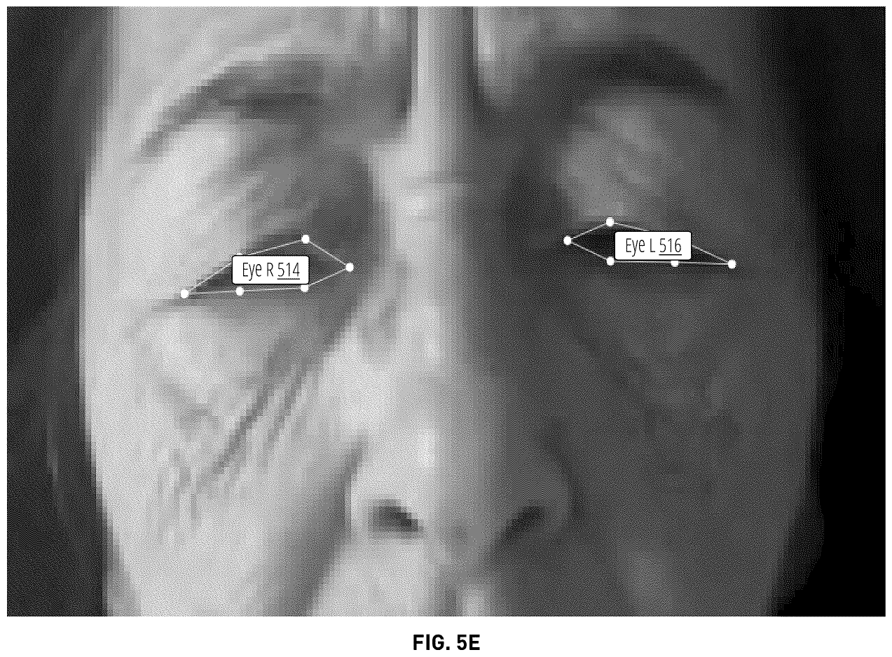

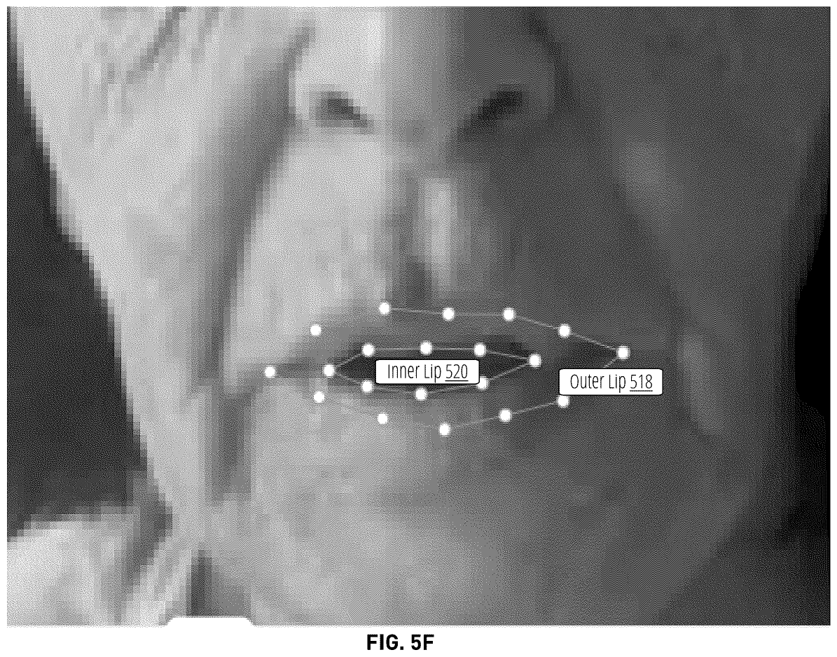

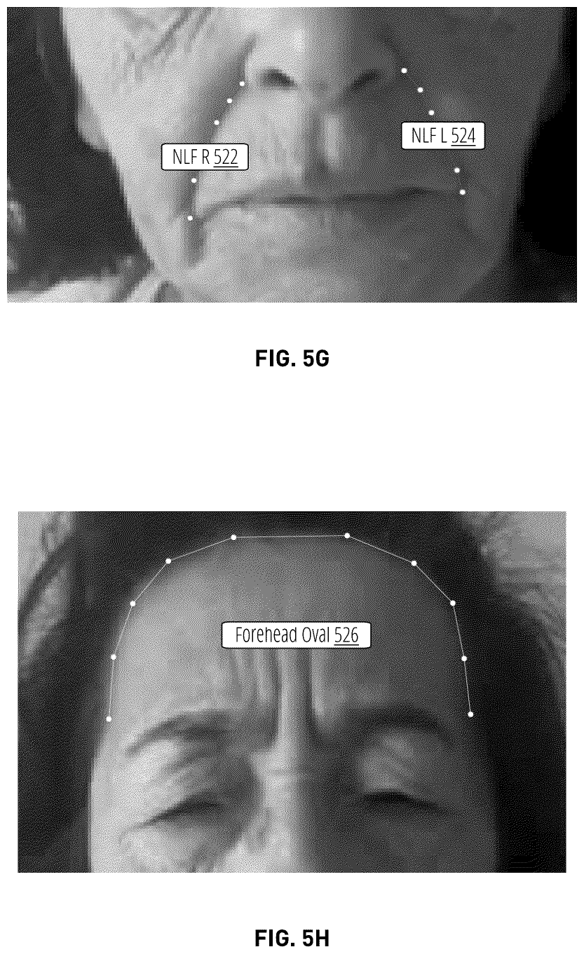

In some embodiments, the facial landmark detector 314 may be trained to extract a standard 68 key points that are widely used by the machine learning community. See, for example, Hohman, Marc H., et al. “Determining the threshold for asymmetry detection in facial expressions,” The Laryngoscope 124.4 (2014): 860-865. In other embodiments, however, the facial landmark detector 314 may be trained on a custom set of facial landmark points that has been identified by stroke specialists. For example, as discussed herein with respect to FIG. 5A to FIG. 5H, certain embodiments use at least 90 location points to define facial landmarks for stroke detection.

The features generator 316 is configured to determine a set of facial feature vectors from the facial landmarks for each of the sequence of video frames. In some cases, directly processing the coordinates of the detected landmark points may yield a classifier with poor generalization capabilities as it may be sensitive to the location and orientation of the face in the image. To reduce or avoid these issues, the facial landmark points may be converted into a set of distances Dᵢ={L₂(l_{i,j}, l_{i,k})|l_{i,j}, l_{i,k}∈Lᵢ, i≠j} with cardinality

$$\vert {D}_{i} \vert = \frac{K * ( K - 1 )}{2}$$

and then a dimensionality reduction may be performed using principal components analysis (PCA) to obtain a final feature vector xᵢ^{face}∈ [symbol] ^{q} for every video frame Fᵢ, where q is the target dimensionality for the PCA step. In some example embodiments, q=100 may be sufficient to explain more than 99% of the variance in Dᵢ (e.g., for K=68 or K=90).

### C. Presence of Facial Asymmetry

The classification module 318, which may include or may be referred to as a facial asymmetry module or submodule, includes an AI/ML model trained to determine a presence of facial asymmetry based on the set of facial feature vectors. To do so, the classification module 318 may use a classifier f_{asymmetry} that takes as an input xᵢ^{face} and outputs ŷᵢ^{face}=p(y_{asymmetry}=1|x=xᵢ^{face})=f_{asymmetry}(xᵢ^{face}), where y_{asymmetry}∈{0, 1} may indicate the presence of facial asymmetry. After extensive model comparison, the inventors of the present application determined that a linear discriminant analysis (LDA) is well suited for this classification task.

In certain embodiments, a fully connected neural network with three hidden layers is used for the classification. Processing every frame Fᵢ, i∈{1, . . . , N} in the video may result in N predictions

$${\hat{y}}_{1 , … , N}^{f a c e}$$

that may be aggregated using a kernel density estimation (KDE) to determine a mean predicted probability of asymmetry as well as an uncertainty of the estimate.

### D. Differentiating Peripheral Vs Central Asymmetry

A peripheral pattern of facial weakness involves upper and lower facial muscles, whereas a central pattern of facial weakness can be more subtle and typically involves only the lower part of the face. Thus, in certain embodiments, the classification module 318 comprises an AI/ML model configured to differentiate between a peripheral pattern of facial asymmetry (symptomatic of Bell's palsy) versus a central pattern of facial asymmetry (symptomatic of a stroke). For example, in one embodiment, the AI/ML model of the classification module 318 was trained using data collected from patients with confirmed diagnoses of stroke (Nₛ=286), healthy controls (N_{H}=71), and Bell's palsy (N_{B}=44) across five major metropolitan stroke centers. Speech and facial data were acquired via smartphone video recordings, while arm data were captured using device sensors. The collected data and corresponding neurologists' annotations were provided as input to train the AI/ML model to specifically differentiate between peripheral patterns of facial asymmetry and central patterns of facial asymmetry.

Thus, the AI/ML model of the classification module 318 provides a first classification to determine a presence of facial asymmetry based on the set of facial feature vectors and a second classification wherein a set of pairwise distances Dᵢ for all frames with detected facial asymmetry are provided to an additional set of dimensionality reduction and classification stages. PCA is used to map Dᵢ to a feature vector xᵢ^{peripheral}∈R^{q}, where q is the target dimensionality for the PCA step. In some example embodiments, a hyperparameter search determined that q=200 is suited for differentiating between peripheral and central asymmetry patterns. The feature vectors are subsequently passed into a fully connected neural network with three hidden layers fₚₑᵣᵢₚₕₑᵣₐₗ to estimate the probability of peripheral asymmetry ŷᵢ^{peripheral}=p(yₚₑᵣᵢₚₕₑᵣₐₗ=1|x=xᵢ^{peripheral})=fₚₑᵣᵢₚₕₑᵣₐₗ(xᵢ^{peripheral}), where yₚₑᵣᵢₚₕₑᵣₐₗ∈{0, 1}. Processing every frame Fᵢ, i∈{1, . . . , N} in the video results in N predictions ŷᵢ^{peripheral} that are aggregated using KDE to calculate the mean predicted probability and assess the uncertainty of the estimate.

### E. Analysis of Affected Side

In addition, certain embodiments include a lateral analysis submodule 320 to perform a lateral analysis of observed face movements to identify which side of the face is likely affected. The analysis may be based on measuring the total movement of the left and right sides of the face and determining which side has moved less throughout the observed video. In particular, the set of normalized facial landmark points Lᵢ={l_{i,1}, l_{i,2}, . . . , l_{i,K}} may be split into subsets L_{i,left} and L_{i,right} including the facial landmark points that belong to the left and right side of the face, respectively, detected at video frame Fᵢ. Any points along the central vertical line of the face are included in both sets. The total displacement of facial landmark points on each side of the face may be estimated as d_{i,left}=Σₗ_{_{i,j}}_{∈L}_{_{i,left}}L₂(l_{i,j}, e_{i,left}) and d_{i,right}=Σₗ_{_{i,j}}_{∈L}_{_{i,right}}L₂(l_{i,j}, e_{i,right}), where e_{i,left} and e_{i,right} denote the locations of the center of the left eye and the right eye, respectively, in frame Fᵢ, and L₂ denotes the Euclidean norm. Processing the sequence of video frames results in the sequences d_{1,left}, d_{2,left}, . . . , d_{N,left} and d_{1,right}, d_{2,right}, . . . , d_{N,right} whose variances σ²_{left} and σ²_{right} indicate how much the left and right side of the face has moved throughout the video. The side with the lower variance is predicted to be the affected side 306.

Thus, the pipeline shown in FIG. 3 automates the detection of facial asymmetry, which is one of the symptoms assessed by the FAST protocol.

### Examples of Facial Asymmetry Model Output Overlaid on Patient's Image

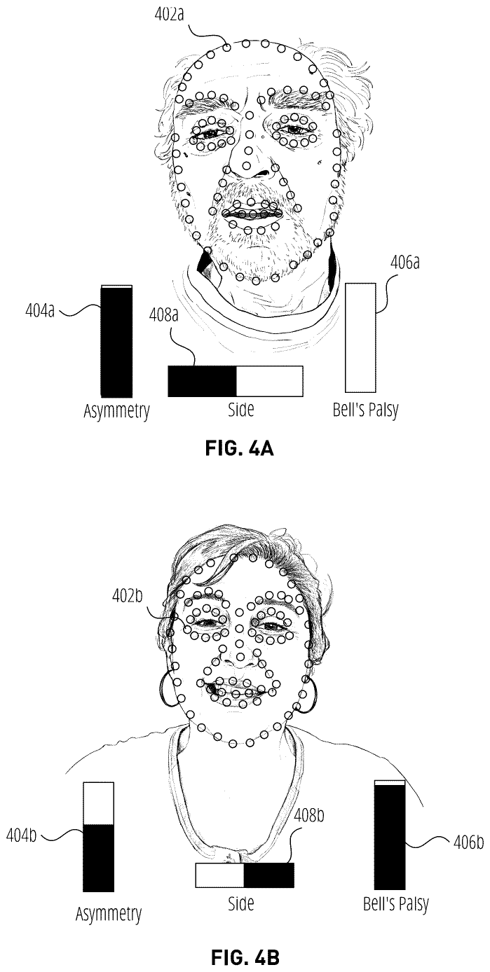

In certain embodiments, the results of the facial asymmetry analysis are displayed as images of the patient's face overlaid with output data such as facial landmark points and indicia of AI/ML model outputs of the classification module 318 and the lateral analysis submodule 320. For example, FIG. 4A and FIG. 4B represent output images or AR video of a patients' faces overlaid with facial landmark points 402a, 402b (shown as circles), asymmetry indicia 404a, 404b (shown as a left vertical bar) representing the probability of asymmetry present, Bell's palsy indicia 406a, 406b (shown as a right vertical bar) representing the probability of Bell's palsy, and affected side indicia 408a, 408b (shown as a horizontal bar) indicating the affected side of the patient's face.

In the example shown in FIG. 4A, the vertical bar of asymmetry indicia 404a is nearly completely filled, the vertical bar of the Bell's palsy indicia 406a is not filled, and the affected side indicia 408a is filled on a right side of the patient's face to represent that the patient has a very high probability of right-sided facial asymmetry with very low probability of Bell's palsy, which is indicative of a central pattern of facial weakness (consistent with likely stroke).

In the example shown in FIG. 4B, the vertical bar of the asymmetry indicia 404b is partially filled (e.g., more than 50%), the vertical bar of the Bell's palsy indicia 406b is nearly completely filled, and the affected side indicia 408b is filled on a left side of the patient's face to represent that the patient has a high probability of facial asymmetry with a high probability of Bell's palsy.

As discussed above, in some embodiments, the facial landmark detector 314 may be trained to extract at least 90 points to identify, define, or track facial landmarks. For example, FIG. 5A, FIG. 5B, FIG. 5C, FIG. 5D, FIG. 5E, FIG. 5F, FIG. 5G, and FIG. 5H are annotated images of a patient's face wherein 90 location points are used to define thirteen different classes of facial landmarks according to one embodiment. The annotations and facial landmarks are used to determine facial asymmetry in a video input of the patient while they are talking and/or making facial expressions. Groups of the location points are connected and form a curve or shape corresponding to a respective part of the face.

In this example, the annotations include Cheek R 502 and Cheek L 504, which are intentionally partially covered in FIG. 5A and shown in FIG. 5B. The annotation Cheek R 502 corresponds to the right cheek and includes nine points placed on the right side of the face (from the patient's point of view). The first point may begin from the upper end of the right ear (if the right ear is visible) or from the lower end of the right eyebrow (if the right ear is not visible). The location points may follow the contour of the face down to the bottom edge of the chin and may be distributed as evenly as possible.

The annotation Cheek L 504 corresponds to the left cheek and includes eight points that may be placed on the left side of the face (from patient's point of view). The first point may begin from the left edge of the chin, symmetrical to the second to last point from the Cheek R 502. Each location point may follow the contour of the face up to the upper end of the left ear (if the left ear is visible) or to the lower end of the left eyebrow (if the left ear is not visible).

In this example, the annotations also include Eyebrow R 506 and Eyebrow L 508 shown in FIG. 5A and FIG. 5C. The annotation Eyebrow R 506 includes five points that may be placed on the right eyebrow (from the patient's point of view). The location points may start from the outer corner and end on the inner corner of the right eyebrow. The location points may follow the upper contour of the right eyebrow and may be distributed as evenly as possible.

The annotation Eyebrow L 508 includes five points that may be placed on the left eyebrow (from the patient's point of view). The location points may start from the inner corner and end on the outer corner of the left eyebrow. The location points may follow the upper contour of the left eyebrow and may be distributed as evenly as possible.

In this example, the annotations also include Nose midline 510 and Nose horizontal 512 shown in FIG. 5A and FIG. 5D. The annotation Nose midline 510 includes four points that may start from the center between the eyebrows and end on the tip of the nose. The other location points may follow the front contour of the nose and may be distributed as evenly as possible.

The Nose horizontal 512 includes five points that may begin with a first point on the right outer tip of the right nostril (from the patient's point of view). A second point may be on the inner edge of the right nostril. A third point may be between the two nostrils. A fourth point may be on the inner edge of the left nostril. A last point may be on the outer tip of the left nostril.

In this example, the annotations also include Eye R 514 and Eye L 516 shown in FIG. 5A and FIG. 5E. The Eye R 514 includes six points placed on the right eye (from the patient's point of view). A first point may be placed on the outer edge of the right eye. The next point may be placed on the inner edge of the right eye. The location points may be associated with identifiers (IDs) and be placed clockwise. The other four points may be placed on the outer contours of the right eye so that a first pair of points are aligned vertically and a second pair of points are aligned vertically. If the right eye is completely shut, then the first pair of points may at least partially overlap and the second pair of points may at least partially overlap.

The Eye L 516 includes six points placed on the left eye (from the patient's point of view). A first point may be placed on the inner edge of the left eye. The next point may be placed on the outer edge of the left eye. The location points may be associated with IDs and be placed clockwise. The other four points may be placed on the outer contours of the left eye so that a first pair of points are aligned vertically and a second pair of points are aligned vertically. If the left eye is completely shut, then the first pair of points may at least partially overlap and the second pair of points may at least partially overlap.

In this example, the annotations also include Outer Lip 518 and Inner Lip 520 shown in FIG. 5F. In FIG. 5A, Outer Lip 518 is intentionally covered (although many of the corresponding location points are shown) and Inner Lip 520 is shown as “Lip inner circle” (with many of the corresponding location points being covered).

The Outer Lip 518 includes twelve points placed on the outer contours of the mouth of the patient. A first point may be placed on the right edge of the lips (from the patient's point of view). A second point may be placed on the left edge of the lips. The rest of the points may follow the outer contour and are arranged such that each point on the upper lip may be vertically aligned to each point on the bottom lip.

The Inner Lip 520 includes eight points that may be placed on the inner contours of the lips of the patient. A first point may be placed on the right edge of the inner contour (from the patient's point of view). A second point may be placed on the left edge. The rest of the points may follow the inner contour of the lips as they follow an open mouth. Each upper point may be vertically aligned to each lower point. The points may be evenly distributed along the lips edges. The corresponding points may at least partially coincide when the mouth is shut.

In this example, the annotations also include NLF R 522 and NLF L 524 shown in FIG. 5A and FIG. 5G. The NLF R 522 includes six points that may be placed along patient's nasolabial fold (NLF) on the right side of the face (from the patient's point of view). The points may start from the right outer edge of the nose and may be distributed evenly down the NLF to the right outer edge of the mouth.

The NLF L 524 includes six points that may be placed on the left side of the face (from the patient's point of view). The points may start from the left outer edge of the nose and may be distributed evenly down the NLF to the left outer edge of the mouth.

In this example, the annotations also include Forehead Oval 526 shown in FIG. 5A and FIG. 5H. The Forehead Oval 526 includes ten points that may be placed on the forehead of the patient and may follow the outer contours of the head and the hairline of the forehead. A first point may be placed on the right temple (from the patient's point of view). A second point may be placed on the left temple (from the patient's point of view). The rest of the points may follow the hairline.

### III. Detecting Arm Weakness from Motion Data

Various embodiments may be used to collect arm weakness data from a patient. For example, a patient may hold a mobile phone in their hand while the mobile app guides them through various movements as the mobile phone's sensors generate three dimensional (3D) motion data such as acceleration, angular velocity, and direction. The sensor data can also be obtained from a separate device mounted on a bracelet and wirelessly connected to a computer or a mobile device such as smartphone, tablet, or laptop computer.

### A. Example Arm Weakness Assessment Via Wearable Sensor

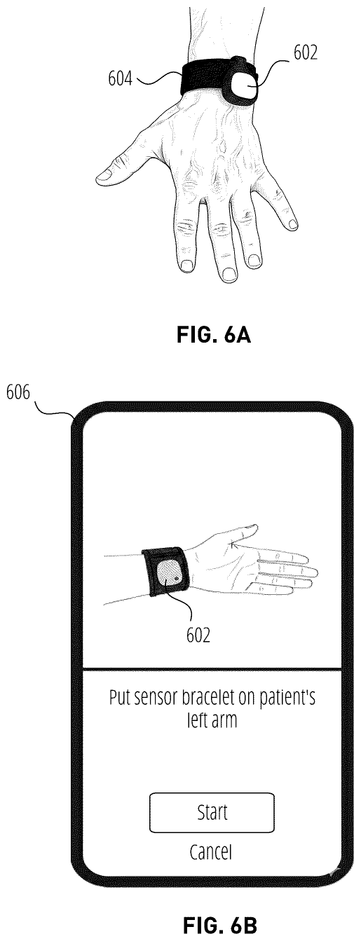

FIG. 6A illustrates a wearable device 602 that may be worn by a patient, according to certain embodiments. In the illustrated example, the wearable device 602 is removably attached to a band 604 sized and configured to be worn on the patient's wrist. However, skilled persons will recognize from the disclosure herein that the wearable device 602 may also be worn on the patient's arm, hand, or finger. The wearable device 602 includes motion sensors such as an accelerometer, magnetometer, and/or gyroscope.

FIG. 6B illustrates an example display of a mobile phone 606 used to instruct the use of, and collect data from, the wearable device 602 shown in FIG. 6A, according to certain embodiments. In the illustrated example, a mobile app executing on the mobile phone 606 displays how the wearable device 602 is to be worn and provide written and/or verbal instructions. For example the mobile app may instruct that the sensor wearable device 602 is placed on the patient's wrist with a sensor button and/or light indicator facing user (e.g., physician or other person assisting the patient). The mobile app may then instruct the user to pair the wearable device 602 to the mobile phone 606 and/or activate the test procedure by holding the mobile phone 606 near the sensor until its light indicator starts to blink. The patient may then be instructed to rest the arm with the sensor next to their body, which may be followed by an instruction to lift the arm and hold it (e.g., for 10 seconds). During the “Lift and Hold” task, the sensors in the wearable device 602 collect pitch data. In certain embodiments, the sensor sampling rate is approximately 96.5 readings per second. The wearable device 602 provides the collected data to the mobile app, which uses an AI/ML model trained to detect arm weakness. For example, the AI/ML model may output indicating a “normal” result when the pitch stays above −0.2 radians (rad) (≈−12°) for more than 70% of the sensor readings, a “moderate” result when the pitch stays between −0.2 rad (≈−12°) and −0.8 rad (≈−45°) for more than 70% of the sensor readings, and a “severe” result when the pitch stays below-0.8 rad (≈−45°) for more than 70% of the sensor readings.

### B. Example Arm Weakness Assessment Via Video-Enabled Computer Vision

In certain embodiments, video-enabled computer vision is used instead of, or in addition to, sensor data to analyze arm weakness. A video-enabled process may be initiated when the patient is instructed to raise and hold each arm in a specific position (e.g., for 10 seconds) while the user (e.g., physician or other person assisting the patient) records the activity using a video camera (e.g., on a smartphone or tablet). During the evaluation, the patient is instructed to raise and hold each arm various positions while the mobile app records the activity. The mobile app uses computer vision algorithms to map predetermined body landmarks (e.g., the arms, shoulders, and/or torso) and track the movement of each arm in 3D space. The mobile app extracts features such as hold duration, arm drift, movement speed, alignment, and/or symmetry between the arms. These features are analyzed using an AI/ML model to identify patterns of weakness that are then classified as normal or abnormal. If abnormalities are detected, the AI/ML model assigns a severity score to quantify the extent and laterality of the weakness. The mobile app uses output from the AI/ML model to generate a detailed report highlighting the findings, including the type and severity of weakness, visualizations of arm trajectories, and/or comparative analysis of movements.

### C. AI/ML Model for Detecting Arm Weakness

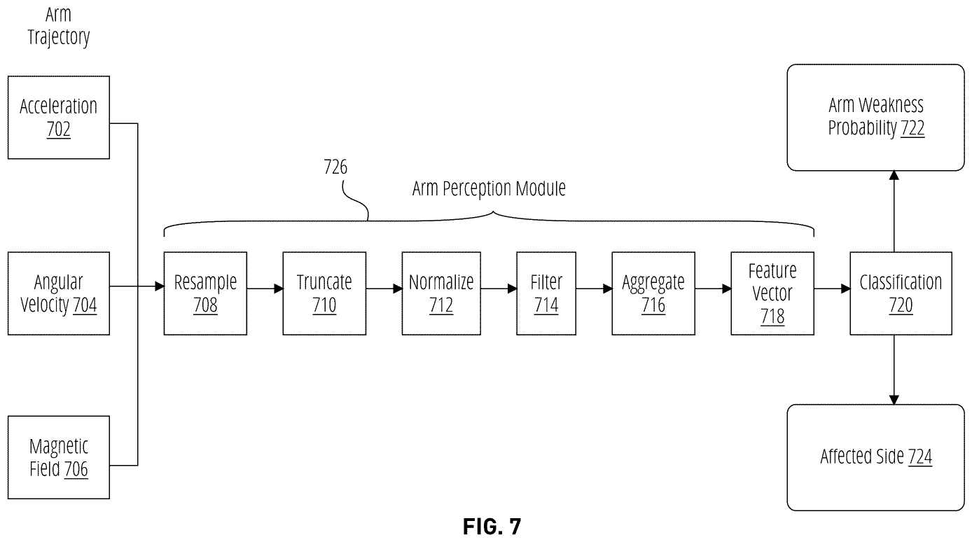

FIG. 7 illustrates an example processing flow of a pipeline for detecting arm weakness by analyzing various motion specific metrics with an AI/ML model, according to certain embodiments. As discussed above, for example, the subject may hold or wear a device with sensors that may record any, or all, of the input motion signals. In other embodiments, video from one or more cameras may be processed to obtain the input motion signals.

The input motion signals may be processed through multiple stages to predict the probability of arm weakness. Also, by comparing predictions made for the left and right arm, the affected side may also be identified.

In some embodiments, detecting arm weakness may be a symptom assessed by the FAST protocol. As prescribed by the FAST protocol, the test subject may be asked to steadily raise their hands sideways or forward and keep that position for several seconds. In this example, the disclosed method for arm weakness detection assumes that the patient holds in their hand, or alternatively wears on their hand or arm, a one or more devices that may be capable or capturing one or more signals including: a 3D acceleration signal 702 denoted as

$${x}_{1 , … , {N}_{accel}}^{a c c e l}$$

where

$${x}_{i}^{a c c e l} ∈ {ℝ}^{3}$$

anu N_{accel} is the number of acceleration measurements; a 3D angular velocity signal 704 denoted as

$${x}_{1 , … , {N}_{gyro}}^{g y r o}$$

where

$${x}_{i}^{g y r o} ∈ {ℝ}^{3}$$

and N_{gyro} is the number of angular velocity measurements; and a 3D magnetic field direction signal 706 denoted as

$${x}_{1 , … , {N}_{magnet}}^{magnet}$$

where

$${x}_{i}^{magnet} ∈ {ℝ}^{3}$$

and N_{magnet} is the number of magnetic field measurements.

In certain embodiments, the perception module 208 shown in FIG. 2 includes an arm perception module 726, as shown in the pipeline of FIG. 7. As discussed below, the arm perception module 726 is configured to resample 708, truncate 710, normalize 712, filter 714, aggregate 716, and generate a feature vector 718 from the acceleration signal 702, the angular velocity signal 704, and the magnetic field direction signal 706.

In general, N_{accel}≠N_{gyro}≠N_{magnet} as these signals may be sampled with different frequencies throughout a duration T of the arm weakness test. Therefore, a first step of the arm data processing pipeline may be for the arm perception module 726 to resample 708 the signals to a fixed frequency

$${f}_{s a m ple}^{arm} ,$$

which may result in

$$\hat{N} = {Tf}_{s a mple}^{arm}$$

samples for each of the signal modalities resulting in a resampled signals

$${\hat{x}}_{1 , ⋯ , \hat{N}}^{accel} , {\hat{x}}_{1 , ⋯ , \hat{N}}^{gyro} , {\hat{x}}_{1 , ⋯ , \hat{N}}^{magnet}$$

that have equal sampling frequency and length. The resampling procedure may be performed via piecewise linear interpolation. Furthermore, it may be beneficial to truncate 710 the resampled signals by dropping a small number of samples at the beginning and the end of the test in order to filter out any transitionary artifacts.

In some embodiments, a challenge may be that a person may hold the sensor device with various grasps and in different orientations. Therefore, in certain such embodiments, a z-score is used to normalize 712 the magnitude of each 3D measurement resulting in

$${s}_{1 , ⋯ , \hat{N}}^{accel} , {s}_{1 , ⋯ , \hat{N}}^{gyro} , {s}_{1 , ⋯ , \hat{N}}^{magnet} ,$$

where

$${s}_{i}^{M} = {L}_{2} ( {x}_{i}^{M} )$$

with M∈{accel, gyro, magnet}, and L₂ denotes the Euclidean norm. Z-score normalization may be further applied resulting in

$${\hat{s}}_{i}^{M} = \frac{{s}_{i}^{M} - {μ}^{M}}{{σ}^{M}} ,$$

where

$${μ}^{M} = E [ {s}_{1 , ⋯ , \hat{N}}^{M} ]$$

and variance

$${σ}^{M} = Var ( {s}_{1 , ⋯ , \hat{N}}^{M} ) .$$

Additionally, the arm perception module 726 may filter 714 the normalized signals, e.g., using a Butterworth low pass filter with cutoff frequency

$${f}_{cutoff}^{arm} ,$$

to remove high frequency noise artifacts. Then, the arm perception module 726 may aggregate 716 the normalized 712 and filtered 714 signals and generate a single feature vector 718 by concatenation, which results in x^{arm}∈ [symbol] ^{3\hat{N}}. The test may be performed for both arms results in

$${x}_{left}^{arm} , {x}_{right}^{arm} ∈ {ℝ}^{3 \hat{N}} .$$

The pipeline for detecting arm weakness shown in FIG. 7 includes a classification module 720 to evaluate whether arm weakness is present or not. The classification module 720 outputs an arm weakness probability 722 and an indication of an affected side 724. The classification module 720 may use a classifier f_{weakness} takes as an input x^{arm} and outputs ŷ^{arm}=p(y_{weakness}=1|x=x^{arm})=f_{weakness}(x^{arm}), where y_{weakness}∈{0, 1} indicates the probability of a presence of arm weakness. After extensive model comparison, the inventors of the present application determined that logistic regression (LR) is well suited for this classification task. If the output of the classifier for either of the arms is positive then arm weakness may be predicted to be present.

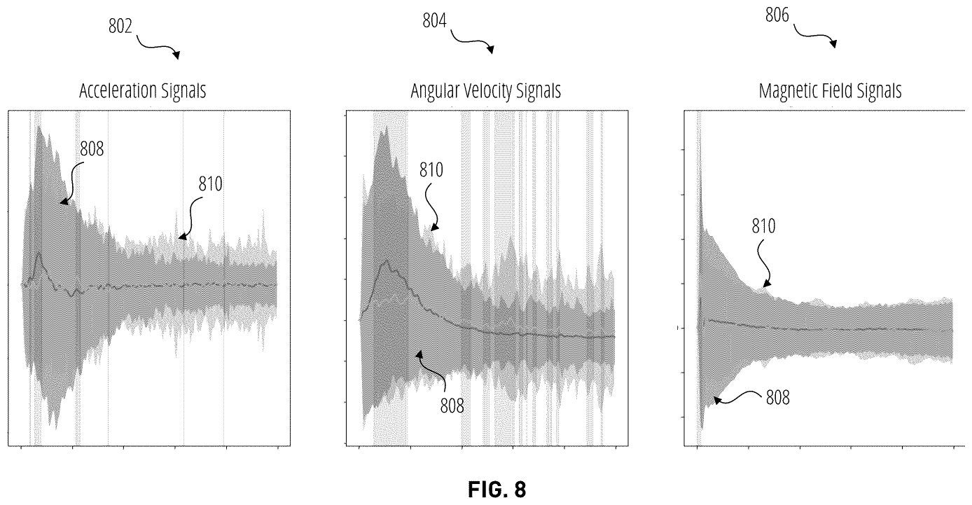

By way of example, FIG. 8 illustrates filtered and normalized acceleration signals 802, angular velocity signals 804, and magnetic field signals 806 processed according to certain embodiments described with respect to FIG. 7. Signals 808 are from healthy patients (shown in a relatively darker gray) and signals 810 are from stroke affected patients (shown in a relatively lighter gray), with solid lines representing a mean trajectory and the relatively darker gray or lighter gray regions around the solid lines representing 1σ uncertainty ranges.

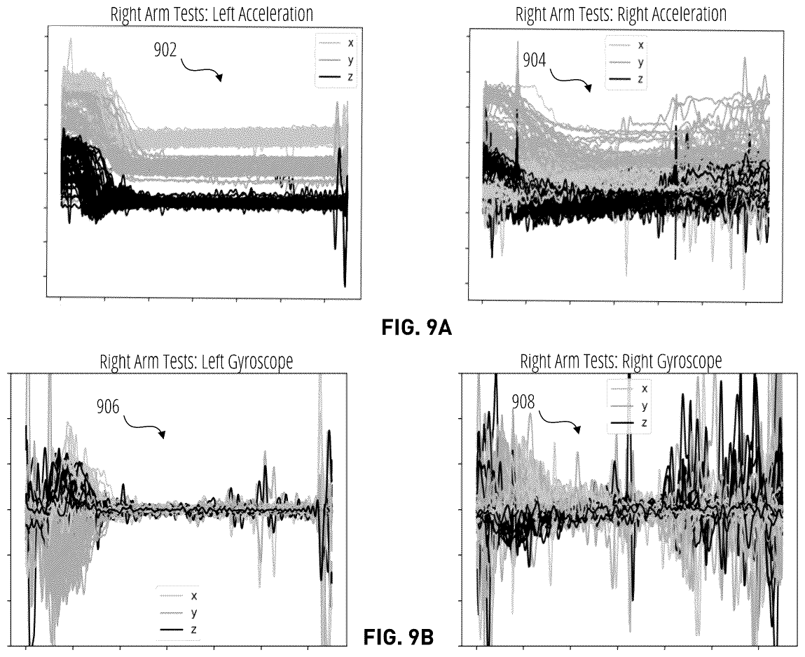

FIG. 9A illustrates example acceleration signals processed according to certain embodiments described with respect to FIG. 7. The acceleration signals were acquired using an accelerometer for a right arm of a person affected by stroke. The acceleration signals 902 correspond to left acceleration of the right arm in an x-axis, a y-axis, and a z-axis. The acceleration signals 904 correspond to right acceleration of the right arm in the x-axis, the y-axis, and the z-axis. The acceleration signals 904 show more variance than the acceleration signals 902, which may indicate arm weakness affected by stroke.

FIG. 9B illustrates example angular velocity signals processed according to certain embodiments described with respect to FIG. 7. The angular velocity signals were acquired using a gyroscope for a right arm of a person affected by stroke. The angular velocity signals 906 correspond to left rotation of the right arm in an x-axis, a y-axis, and a z-axis. The angular velocity signals 908 correspond to right rotation of the right arm in the x-axis, the y-axis, and the z-axis. The angular velocity signals 908 show more variance than the angular velocity signals 906, which may indicate arm weakness affected by stroke.

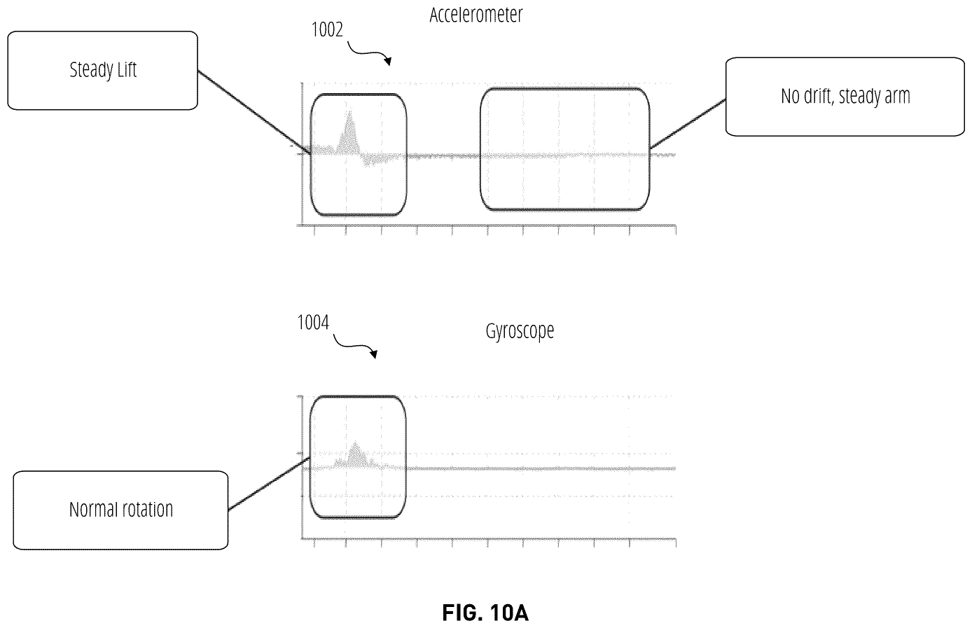

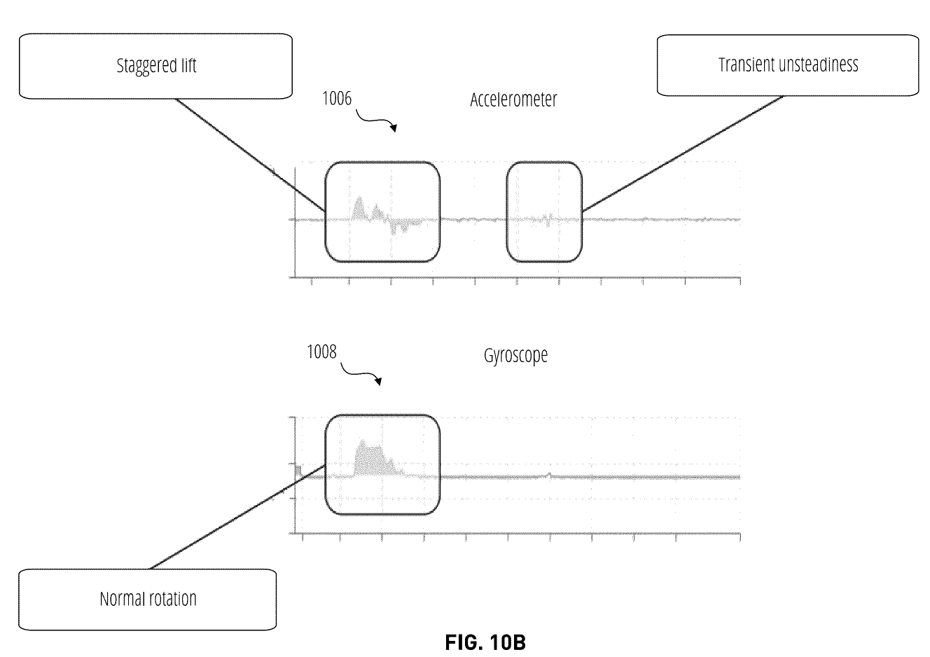

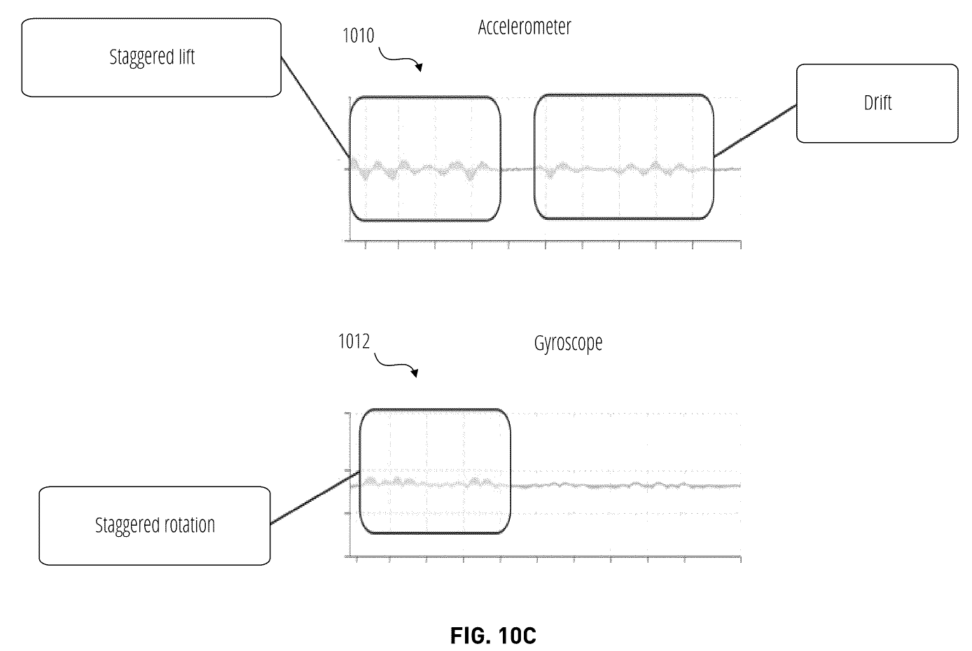

FIG. 10A illustrates example acceleration signals 1002 and angular velocity signals 1004 processed according to certain embodiments described with respect to FIG. 7 for an arm of a healthy person. The acceleration signals 1002 were measured with an accelerometer and show an area of steady lift and an area of no drift indicating a steady arm. The angular velocity signals 1004 were measured with a gyroscope and show an area of normal rotation.

FIG. 10B illustrates example acceleration signals 1006 and angular velocity signals 1008 processed according to certain embodiments described with respect to FIG. 7 for an arm with subtle weakness. The acceleration signals 1006 were measured with an accelerometer and show an area of staggered lift and an area of transient unsteadiness. The angular velocity signals 1008 were measured with a gyroscope and show an area of normal rotation. The indicated subtle weakness may or may not be a sign of stroke, but may contribute to a prediction of stroke when combined with the other tests of the FAST protocol.

FIG. 10C illustrates example acceleration signals 1010 and angular velocity signals 1012 processed according to certain embodiments described with respect to FIG. 7 for an arm with moderate weakness. The acceleration signals 1010 show an area of staggered lift and an area of drift. The angular velocity signals 1012 show an area of staggered rotation. The indicated moderate weakness may lead to a prediction of stroke.

### IV. Detecting Slurred Speech

In certain embodiments, an AI/ML model is trained to detect slurred speech or aphasia. The patient may be asked to read aloud several words when prompted. The recorded audio stream is automatically segmented into individual words and labeled in a preprocessing step before it is used as input to the AI/ML model. In addition to a standard spectral analysis of the audio stream, the mobile app is also configured to perform on-device speech recognition. Each word is processed individually in real time and if the speech is sufficiently slurred the word is not recognized. A cumulative score of all correctly pronounced/recognized words is computed.

### A. Example Device-Based Approach

An example device-based approach uses a mobile app on a mobile device such as a mobile phone, tablet, or laptop computer. The patient is instructed to describe a standardized, generally recognized picture (e.g., from an NIHSS assessment). A device-based speech recognition library processes the audio input and converts it into text, which is then split into individual words. The analysis includes an initial check, word categorization, coherence evaluation, and content check. I the initial check, if the response contains two words or fewer, it is deemed incoherent. During the word categorization, each word is categorized by type. The relevant types may include, for example, noun, verb, adjective, adverb, determiner, preposition, pronoun, and/or conjunction. In the coherence evaluation, if at least two-thirds of the words belong to the specified types, the response is deemed coherent. In the content check, if the response is coherent, it is further checked to ensure it contains at least 50% of the words typically used to describe the objects and activities portrayed in the picture; otherwise, it is considered indicative of aphasia.

### B. Example Cloud-Based Approach

In an example cloud-based approach, an audio file-based aphasia model assesses language impairments by analyzing a patient's recorded speech. The process begins with uploading the audio file to a data center and transcribing the audio to text using speech recognition. Then, natural language processing (NLP) algorithms are used to evaluate linguistic features such as grammar, syntax, and coherence. Additionally, an AI/ML model analyzes acoustic features such as pitch, speech rate, and pauses to identify non-verbal indicators of aphasia. By comparing these linguistic and acoustic patterns to known aphasia cases, the model classifies the type and severity of aphasia and generates a detailed report for clinicians to support efficient and accurate diagnosis and intervention planning.

### C. AI/ML Model for Aphasia

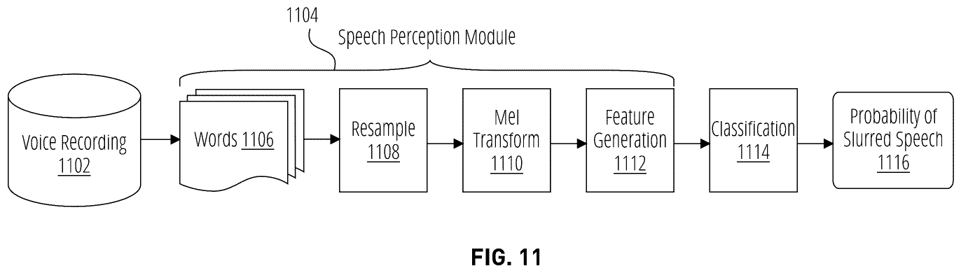

FIG. 11 illustrates an example processing flow of an audio processing pipeline according to one embodiment. In certain embodiments, for example, a voice recording 1102 is generated of a subject reading individual words aloud.

In certain embodiments, the perception module 208 shown in FIG. 2 includes a speech perception module 1104, as shown in the pipeline of FIG. 11. As discussed below, the speech perception module 1104 is configured to divide the voice recording 1102 into audio subsegments (W₁, W₂, . . . , W_{S}) corresponding to respectively pronounced words 1106, resample 1108 the audio subsegments to a target sampling audio frequency to generate resampled audio subsegments, perform a Mel transformation 1110 to calculate a Mel Frequency Cepstral Coefficients (MFCC) matrix for each of the resampled audio subsegments, and perform feature generation 1112 to generate a speech feature vector. The processing pipeline in FIG. 11 also includes a classification module 1114 comprising an AI/ML model to determine a presence of slurred speech by the person based on the speech feature vector. The classification module 1114 outputs a probability of slurred speech 1116, which may indicate a stroke.

In some embodiments, slurred speech may be a symptom assessed by the FAST protocol. The subject may be asked to read aloud several standard words in order for their speech to be assessed. It may be assumed that a voice recording 1102 of this process is available. The recording itself may be made independently or during the video capturing phase disclosed herein.

In some embodiments, words are shown to the test subject in a timed fashion during the voice recording such that the recording may be automatically split into multiple segments, with each one corresponding to a single one of the words 1106. As a result, each test subject voice recording 1102 may be transformed into W₁, W₂, . . . , W_{S} audio subsegments corresponding to each pronounced word where S is the number of words shown to the test subject.

In some embodiments, the speech perception module 1104 processes each word audio segment Wᵢ individually to resample 1108 it to a target sampling audio frequency

$${f}_{sample}^{speech}$$

and then applying the Mel transformation 1110 to it in order to calculate the Mel frequency cepstral coefficients (MFCC). As a result, for each word Wᵢ an MFCC matrix MFCCᵢ may be calculated that has a size of

$${N}_{MFCC} \times {N}_{i}^{speech} ,$$

where N_{MFCC} is the target number of cepstral coefficients and

$${N}_{i}^{speech}$$

is the number of audio sample points within Wᵢ. Given the different duration of each word, the feature generation 1112 may include constructing a fixed length feature vector

$${x}_{i}^{speech} ∈ {ℝ}^{2 {N}_{MFCC}}$$

1112 by calculating the first two statistical moments, for example, the mean and the variance of each cepstral coefficient across time, and concatenating them together into a single vector.

In some embodiments, the classification module 1114 evaluates whether speech slur is present or not. To do so, the classification module 1114 may use a classifier fₛₗᵤᵣ that takes as an input xᵢ^{speech} and outputs ŷᵢ^{speech}=p(yₛₗᵤᵣ=1|x=xᵢ^{speech})=f_{weakness}(xᵢ^{arm}), where yₛₗᵤᵣ∈{0, 1} indicates the presence of slurred speech. After extensive model comparison, the inventors of the present application determined that a Ridge Regression (RR) is well suited for this classification task. Processing the words may result in S predictions

$${\hat{y}}_{1 , ⋯ , N}^{speech} ,$$

which are aggregated using Kernel Density Estimation (KDE) to determine the mean predicted probability of slurred speech 1116 as well as the uncertainty of the estimate.

### V. Gaze Assessment

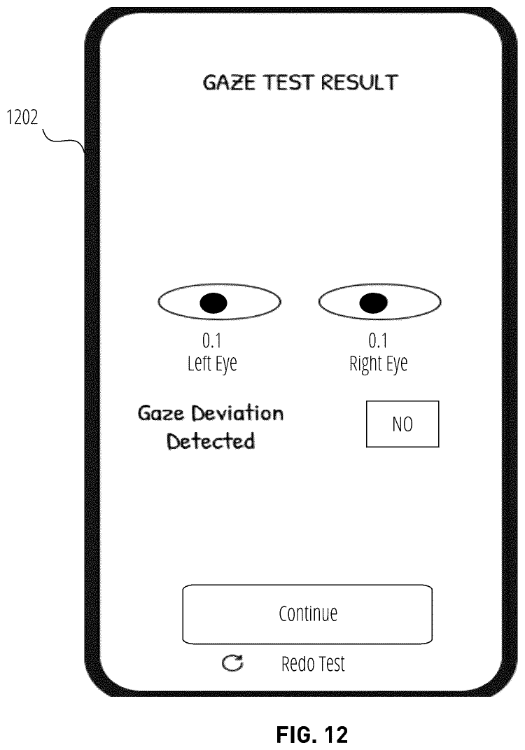

In certain embodiments, the mobile app tracks the patient's eye movements and detects gaze abnormalities that may be further evidence of a stroke. For example, FIG. 12 illustrates an example display of a mobile phone 1202 used to instruct a gaze test and display the results, according to certain embodiments. A mobile app on the mobile phone 1202 may display instructions to follow a dot that moves horizontally across the screen of the mobile phone 1202. During the “Follow the Dot” task, the mobile app uses the video camera of the mobile phone 1202 to collect horizontal direction data for each eye. In certain embodiments, the mobile app also collects point of focus data for each eye. While the patient looks at the point, the collected data are assessed. If the difference between the left and right horizontal direction is more than 0.1 units, the mobile app displays a gaze deviation detection indication of “YES”. If the difference between the left and right horizontal direction is less than or equal to 0.1 units, the mobile app displays a gaze deviation detection indication of “NO”.

In certain embodiments, the mobile app uses an AI/ML model to detect gaze abnormalities through video analysis of the patient's eye movements. The video data is captured while a user (e.g., a physician or other person assisting the patient) records the activity using a camera of a smartphone or table that is processed frame by frame. Features like gaze direction, saccadic movement, and fixation stability are extracted and used to enhance the model's ability to identify patterns over time. The AI/ML model is trained on labeled datasets using algorithms such as convolutional neural networks (CNNs) for frame-based analysis and long short-term memory (LSTM) for temporal sequences, enabling it to differentiate normal from abnormal gaze behaviors. Real-time inference allows the AI/ML model to classify gaze abnormalities (e.g., disconjugate gaze, gaze deviation, and/or gaze palsy) and assign severity scores to aid in tracking and diagnosis.

### VI. Lip-to-Text Model

Certain embodiments provide use language-agnostic lip-to-text model that can accurately transcribe speech based on visual lip movements leveraging multi-modal generative AI techniques. In certain such embodiments, the lip-to-text AI/ML model can be used to perform anomaly detection for stroke detection. As a result, increased specificity and sensitivity for stroke detection is provided while also making the embodiments disclosed herein broadly adoptable regardless of a patient's language.

While certain embodiments may use both a voice analysis AI/ML model and a lip-to-text AI/ML model, other embodiments do not require voice data collection for patient assessment. Instead, facial video is assessed using a language-agnostic lip-to-text model to determine if speech anomalies are present, possibly due to a stroke. In certain such embodiments, video inputs are also used for the assessment of arm motion and/or gaze analysis.

### A. Example Monolingual Lip-to-Text Model Training

In one embodiment, an AI/ML lip-to-text model is trained using a single language (e.g., English) to perform lip reading from video alone. After training the AI/ML model for the single language, its accuracy and system output quality is tested before transforming the model to a language-agnostic AI/ML lip-to-text model. For example, the monolingual AI/ML lip-to-text model can be assessed on a word-level task, which is a multi-class classification problem. Classification accuracy is an evaluation metric for classification models because of its simplicity and efficiency. Top-k accuracy, the standard accuracy of the actual class being equal to any of the k most probable classes predicted by the classification model, is also widely used for this task. As for a sentence-level task (which focuses on measuring transcription accuracy), Character Error Rate (CER) and Word Error Rate (WER), also known as average character-level and word-level edit distances, may be used as evaluation metrics. CER is defined as CER=(S+D+I)/N, where S, D, and I are the numbers of substitutions, deletions, and insertions, respectively, to get from the reference to the hypothesis, and N is the number of characters in the reference. This metric imposes smaller penalties where the predicted string is similar to the ground truth. For example, if the ground truth is “about” and the model prediction is “above”, then CER=0.4. WER and CER are calculated in the same way. The difference lies in whether the formula is applied to character-level or word-level. Other metrics that may be used include the bilingual evaluation understudy (BLEU) score, which focuses on the evaluation text output quality. In an example testing, the monolingual AI/ML lip-to-text model has achieved (as proposed milestones) a word error rate of ≤10% on benchmark datasets such as Lip Reading Sentences-3 (LRS3), TCD-TIMIT, Lip Reading in the Wild (LRW), and has top-1 accuracy scores greater than 50% for English for benchmark datasets like LRW.

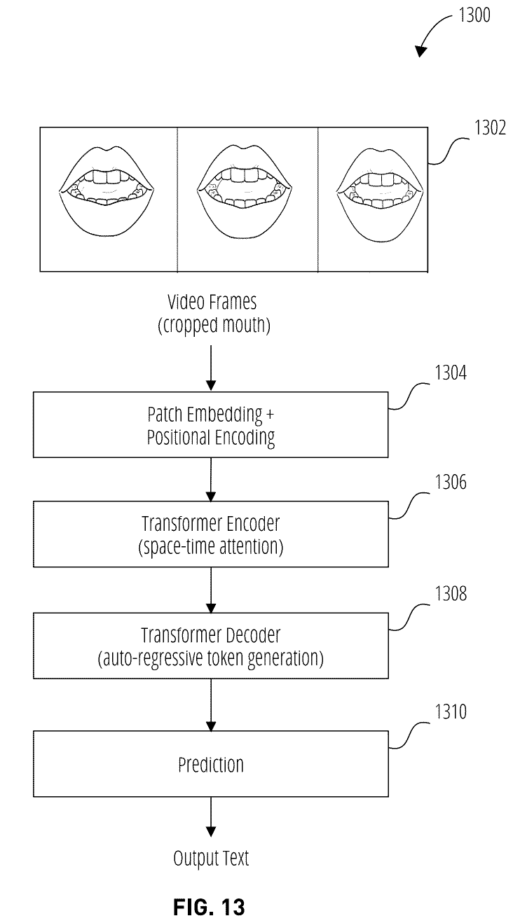

In certain embodiments, the AI/ML lip-to-text model comprises a pure transformer lip-to-text model architecture including transformed-based components trained for encoding video frames and decoding text. For example, FIG. 13 is a block diagram illustrating a transformer lip-to-text model architecture 1300, according to one embodiment. The transformer lip-to-text model architecture 1300 includes an input 1302, a patch embedding layer 1304, a transformer encoder layer 1306, a transformer decoder layer 1308, and a prediction layer 1310.

The input 1302 comprises video frames of lips moving (i.e., cropped video of the patient's mouth). A sequence of frames may include a short video clip (e.g., 25 frames per second (fps) to 30 fps) of an extracted lip region.

The patch embedding layer 1304 splits each video frame into patches (e.g., 16×16 patches) and flatten each patch into a vector. A linear projection is performed to project each patch to an embedding vector (as with a vision transformer (ViT)). Frame positional encoding adds spatial and temporal positional encodings to determine where the patch is in the frame and a corresponding time step of the frame.

The transformer encoder layer 1306 may include one or multiple transformer encoder layers that process the sequence of video patches, with attention across space (within a frame) and time (across frames). The output is a sequence of embeddings capturing mouth movements over time.

The transformer decoder layer 1308 may include a transformer decoder (e.g., as used in machine translation) that generates text tokens (characters or words). At each step, the transformer decoder layer 1308 attends to the visual embeddings from the transformer encoder layer 1306, and predicts the next token.

In the prediction layer 1310, a linear layer and softmax may be used to predict probability distribution over vocabulary (characters and/or words). The prediction layer 1310 provides output text.

In certain embodiments, different training losses are used to train the transformer lip-to-text architecture 1300, beginning with cross-entropy loss between the predicted sequence and the ground truth text sequence. Some example candidate building blocks for the he transformer lip-to-text architecture 1300, for both a lightweight version and heavy implementation are shown in Table 2.

TABLE 2
Candidate building blocks for the pure transformer lip-to-text model

| Stage | Light Model | Heavy Model |
|---|---|---|
| Video Encoder | TimeSformer (tiny) | Video-Swin/ViViT large |
| Decoder | 4-layer Transformer | 12-layer Transformer |
| Vocabulary | Characters (a-z, 0-9) | Words or BPE (Byte Pair Encoding) |
| | | Tokens |

Certain embodiments include fine-tuning some or all of the building blocks of the integrated pure transformer lip-to-text model. Certain such embodiments focus on leveraging the large-scale in-the-wild datasets for training the lip-to-text model and using data from publicly available sources such as the LRS3 and Glasgow University's Audio-Visual Speech Databases (GRID) datasets. The LRS3 dataset comprises thousands of spoken sentences from videos (e.g., videos available on the internet). LRS3 is divided into specific datasets for training, validation, and testing. The statistics of these datasets are shown in Table 3. The GRID dataset includes high-quality audio and video recordings of 1,000 sentences spoken by 34 individuals (18 male, 16 female).

TABLE 3
Datasets available from LRS3

| Set | # Videos | # Utterances | # Word Instances | Vocabulary |
|---|---|---|---|---|
| Training | 5,090 | 118,516 | 3,900,000 | 51,000 |
| Validation | 4,004 | 31,982 | 358,000 | 17,000 |
| Testing | 412 | 1,321 | 10,000 | 2,000 |

In certain embodiments, the lip-to-text recognition pipeline is highly modular and can take different types of input data (e.g., pose as opposed to color images), embedding networks (based on CNNs as opposed to transformers), temporal backend networks for decoding paradigms such as convolutional LSTMs.

During model training, data from the LRS3 validation dataset may be used to evaluate model performance and fine-tune the model as needed. A final evaluation to meet proposed milestones may be accomplished using the test dataset, which is a unique dataset that is completely unseen by the model during training and initial validation. The testing evaluates the word error rate of the lip-to-text model and determines the BLEU score. The BLEU score is a metric used to evaluate the quality of the generation performed by a machine learning algorithm. In both cases, the ground truth may be identified as information provided by LRS3 as well as verification from a human user.

Potential challenges or events during data extraction, model training, and validation may include lip occlusions from features such as mustaches, masks, or shadows. Such events are evaluated as similar situations may occur during use of the AI/ML model of the mobile app in the field. To address this, the AI/ML model may be trained on augmented datasets that feature multiple types of lip occlusions to ensure that it is capable of accurately detecting speech.

In addition, speaker variations or accents could impact the translation. To account for this potential challenge, self-supervised learning (SSL) is used on diverse datasets. This helps ensure that the AI/ML model is robust and capable of understanding patients regardless of their speaking style or accents.

### B. Example Language-Agnostic Lip-to-Text Model Training

To make AI/ML model in the mobile app broadly applicable and improve adoption diverse locations and cultural subgroups, certain embodiments are usable with any population, in any country, and speaking any language. Thus, certain such embodiments expand and train a language-agnostic lip-to-text model by applying additional training of the monolingual (e.g., English) AI/ML lip-to-text model with video-text data from two other languages to make the model language-agnostic in the stroke detection sense.

The language-agnostic AI/ML lip-to-text model, once trained on multiple languages, is capable of lip reading in multiple languages. However, when words are slurred or mispronounced, the model focuses less on exact word reconstruction and more on identifying abnormalities in articulation patterns, timing, and mouth movements that deviate from normal speech. Rather than transcribing perfectly, the language-agnostic AI/ML lip-to-text model detects signs of impaired speech production, which is a symptom of stroke, even if the exact words are partially lost or distorted. In certain embodiments, a milestone is reached when the language-agnostic AI/ML lip-to-text model achieves a word error rate of less than 15% and has a BLEU score of 0.3 for two additional languages (e.g., other than English).

To train the language-agnostic AI/ML lip-to-text model, the pure transformer lip-to-text model that was trained for a single language (e.g., English) is used as a starting point and fine-tuned with video-text data for two other languages. For example, the two additional languages may be Chinese and Russian and the training uses the listed data from the LRW1000 dataset (Chinese Mandarin) and the HAVRUS dataset (Russian).

Beyond word-level prediction, certain embodiments also use a universal phoneme-based prediction strategy for the lip-to-text model. The trained models may then be evaluated by assessing their transcription accuracy across these two non-English languages.

During training, the model may not learn for all languages explored. To address this, we explore a mixture of experts (MoE) approach. Mixture of Experts (MoE) is a machine learning technique where multiple specialized models (experts) are trained on different parts of a problem, and a gating network decides which experts to use for each input. To use a Mixture of Experts approach you first train different expert modules: One expert specializes in English lip movements, another expert specializes in Chinese lip patterns, and another expert handles Russian lip patterns. A gating network looks at the video and decides (based on visual cues like mouth shapes, timing, etc.) which experts to activate. Only the most relevant experts are used to decode the lip movements into text.

During training, the language-agnostic AI/ML lip-to-text model might not learn for all languages explored. To address this, certain embodiments use a mixture of experts (MoE) approach. MoE is a machine learning technique where multiple specialized models (experts) are trained on different parts of a problem, and a gating network decides which experts to use for each input. To use an MoE approach, different expert modules are trained. For example, a first expert specializes in English lip movements, a second expert specializes in Chinese lip patterns, and a third expert handles Russian lip patterns. A gating network looks at the video and decides (based on visual cues like mouth shapes, timing, etc.) which experts to activate. Only the most relevant experts are used to decode the lip movements into text.

### C. Validation of the Language-Agnostic AI/ML Lip-to-Text Model

A goal of the AI/ML model in the mobile app is to help users (e.g., paramedics and physicians) identify patients who experience a stroke. Language anomalies are one symptom of stroke. To validate that the AI/ML model accurately identifies normal versus abnormal speech, certain embodiments use a retrospective analysis of publicly available videos. This validates the AI/ML model's robustness. Meeting or exceeding the sensitivity and specificity of the speech AI/ML model is sufficient for highly accurate stroke detection when used with one or more embodiments herein. In certain embodiments, a milestone is reached when an AI/ML lip-to-text model accurately detects abnormal speech (sensitivity and specificity ≥70%) across at least three languages.

In one example test, a combination of publicly available data was used with a retrospective analysis of data collected during clinical trials. Data from more than 500 patients were collected in a Bulgarian study and additional data from 500+ Spanish-speaking individuals were collected in a Colombian study. The combined data comprises three distinct subgroups: 1) patients with confirmed stroke; 2) patients with Bell's palsy (stroke mimic); and 3) healthy controls. To demonstrate the potential of the language-agnostic lip-to-text AI/ML model, abnormal speech was detected across at least three different languages, including a mix of languages used in training as well as new languages (e.g., Spanish). The latter is an example of zero-shot learning (ZSL), a machine learning technique that enables models to recognize new classes (lip reading in languages for which the lip-to-text model was not trained) without needing examples from those classes. ZSL alleviates the need for creating training sets, and of training the lip-to-text model for new languages (e.g., Spanish). This greatly simplifies the deployment of the system globally. As such, a lip-to-text model trained on English, Chinese, and Russian as a foundation model can be adapted to detect stroke symptoms in people who speak languages other than these.

Table 4 some example potential pitfalls for training and lip-to-text AI/ML model and corresponding solutions.

TABLE 4
Potential pitfalls and solutions

| Potential Pitfall | Solution |
|---|---|
| Limited access to suitable | Expand the search to include broader datasets such as media |
| public videos showing | interviews, reality TV, educational videos, and medical |
| abnormal speech | simulation footage. If needed, synthetically augment existing |
| | videos to simulate speech anomalies. |
| Class imbalance (too few | Apply data augmentation techniques (e.g., temporal |
| examples of abnormal | distortion, insertion of stutters, facial perturbations) to |
| speech) | artificially balance the dataset. Alternatively, oversample |
| | abnormal cases during training and evaluation. |
| Inconsistent video quality | Implement a pre-processing pipeline to standardize video |
| (e.g., low resolution, | input (cropping, stabilization, resolution upscaling) and train |
| lighting variations) | the model to be robust to such noise through data |
| | augmentation. |
| Cross-language variability | Introduce expert-informed alignment methods or lightweight |
| (different languages show | language-adaptive modules within the lip-to-text model to |
| different mouth | fine-tune for small language-specific variations without |
| movements for the same | retraining the entire model. |
| sounds) | |
| Ethical or copyright | Carefully vet all sources for licensing rights and consider |
| concerns with public | using videos explicitly released for research purposes or |
| video usage | under creative commons licenses. Obtain institutional |
| | approval as needed. |

The development of the lip-to-text foundation model brings improves the accuracy of AI-assisted stroke detection and simplifies the process as no audio recording is needed. In addition, it allows the mobile app to be used with patients speaking any language via zero shot learning.

### VII. Detecting Stroke

Certain embodiments merge the predictions of each of the data modalities (e.g., facial asymmetry, arm weakness, slurred speech (e.g., via audio analysis and/or lip-to-text analysis), and/or gaze abnormality) by weighing them according to a clinician's expertise as well as by learning from data. Another classifier fₛₜᵣₒₖₑ may be used that takes as an input the predictions made by f_{asymmetry}, f_{weakness}, fₛₗᵤᵣ and outputs p(yₛₜᵣₒₖₑ=1). After extensive model comparison, the inventors of the present application determined that a fully connected neural network with two layers is well suited for this classification task.

In some examples, the model disclosed herein is a fully connected neural network with two hidden layers with 100 neurons at each layer and rectified linear unit (ReLU) activation. In certain such examples the ReLU activation is a threshold function that returns the input value if it is positive or zero, and returns zero for any negative input. Mathematically, it may introduce a non-linearity to the neural network model, which enables the network to learn complex patterns and make non-linear transformations.

In some examples, the model may be based on supervised learning wherein labels are provided from a neurological examination. The models disclosed herein, for the disclosed modalities (including stroke prediction), are binary classification models. Thus the models use, for example, the binary entropy loss function as a loss function. The classifiers for each of the modalities (face, arm, speech) may be trained individually and the stroke classifier may be trained separately on output of the other three. classifiers

In some embodiments disclosed herein, probabilities produced by the classifiers may be viewed as a threshold to produce a yes or no answer. The probability may not have to be calibrated to be utilized and may be utilized as a binary output. For example, a produced probably, by a classifier, may result in a yes or no answer.

### VIII. Example Experimental Results

Certain embodiments disclosed herein have been tested using data collected from X number of patients.

### First Example Results

In a first example, the collected is split for each of the proposed modalities into the subsets shown in Table 5.

TABLE 5
Patient Conditions and Modalities

| | | | Facial | |
|---|---|---|---|---|
| | Slurred Speech | Arm Weakness | Asymmetry | Stroke |
| Healthy | 36 | 93 | 28 | 25 |
| Affected | 105 | 124 | 122 | 54 |
| Total | 141 | 217 | 150 | 79 |

For every patient, both test data including video, arm motion and speech as well as neurological examination data were collected to provide the ground truth for a training procedure. The models f_{asymmetry}, f_{weakness}, fₛₗᵤᵣ, fₛₜᵣₒₖₑ were evaluated by running k-fold validation where 30% of the data was used for evaluation and 70% for training. The average results from the cross validation procedure are summarized in Table 6, while the best obtained model performance is shown in Table 7.

TABLE 6
Average model performance from cross
validation with 100 data splits.

| | Slurred | Arm | Facial | |
|---|---|---|---|---|
| | Speech | Weakness | Asymmetry | Stroke |
| Sensitivity | 0.75 | 0.78 | 0.92 | 0.99 |
| | [95% CI | [95% CI (0.77- | [95% CI (0.92- | [95% CI |
| | (0.74-0.76)] | 0.80)] | 0.92)] | (0.95-1.00)] |
| Specificity | 0.75 | 0.79 | 0.78 | 0.90 |
| | [95% CI | [95% CI (0.77- | [95% CI (0.77- | [95% CI |
| | (0.74-0.76)] | 0.81)] | 0.78)] | (0.80-1.00)] |

TABLE 7
Best model performance from cross validation with 100 data splits.

| | Slurred | Arm | Facial | |
|---|---|---|---|---|
| | Speech | Weakness | Asymmetry | Stroke |
| Sensitivity | 0.93 | 0.82 | 1.00 | 1.00 |
| | [95% CI | [95% CI | [95% CI | [95% CI |
| | (0.78-0.99)] | (0.64-0.93)] | (0.9-1.00)] | (0.84-1.00)] |
| Specificity | 0.90 | 1.00 | 0.88 | 1.00 |
| | [95% CI | [95% CI | [95% CI | [95% CI |
| | (0.56-1.00)] | (0.63-1.00)] | (0.47-1.00)] | (0.69-1.00)] |

### Second Example Results

Table 8 shows characteristics of a studied population in second example results.

TABLE 8
Characteristics of studied population in second example

| | |
|---|---|
| Number of patients | 400 |
| Female (N/%) | 181 (45.3%) |
| Age (median) | 69 |
| Hemorrhagic Stroke (N/%) | 22 (5.5%) |
| Ischemic Stroke (N/%) | 264 (66%) |
| Bell's palsy (N/%) | 43 (10.75%) |
| Deficit-Free Controls/TIA | 71 (17.8%) |
| Number of patients used for training of AI/ML algorithms | 280 |
| Number of patients used to test AI/ML algorithms | 120 |

In this example, the sensitivity and specificity for each individual modality was estimated, as well as the multimodal stroke prediction model by comparing the model's predictions on the test set with the clinical assessments provided by the neurologists. The provided results include the mean sensitivity and specificity, and the confidence intervals derived from a K-fold cross-validation training and testing procedure. Results are summarized in Table 9. Each individual modality demonstrated over 70% sensitivity and specificity. Among all individual modalities, the facial asymmetry model demonstrated highest sensitivity (92%). For the stroke model, which combines all three modalities (face, arm, and speech) we achieved 99% sensitivity and 90% specificity. The Bell's palsy model demonstrated relatively lower performance as it relied solely on a single modality (facial asymmetry) and was trained and validated on a small number of patients (N=43), highlighting the inherent difficulty of distinguishing between peripheral and central asymmetry.

TABLE 9
Mean performance for each of the individual modality models and the
multimodal stroke prediction model obtained from cross validation

| | | | | Peripheral | |
|---|---|---|---|---|---|
| | Slurred | Arm | Facial | Asymmetry | |
| | Speech | Weakness | Asymmetry | (Bell's Palsy) | Stroke |
| Sensitivity | 0.75 | 0.78 | 0.92 | 0.78 | 0.99 |
| | [95% CI | [95% CI | [95% CI (0.92- | [95% CI | [95% CI (0.95- |
| | (0.74-0.76)] | (0.77-0.80)] | 0.92)] | (0.76-0.80)] | 1.00)] |
| Specificity | 0.75 | 0.79 | 0.78 | 0.70 | 0.90 |
| | [95% CI | [95% CI | [95% CI (0.77- | [95% CI | [95% CI (0.80- |
| | (0.74-0.76)] | (0.77-0.81)] | 0.78)] | (0.68-0.72)] | 1.00)] |

In one embodiment, the mobile app focused solely on stroke detection as a cloud-based minimum viable product (MVP). In this initial phase, patient data was collected and integrated with neurologist expertise to develop an AI-powered solution, training each component independently (e.g., face weakness detection was trained separately from the arm weakness classifier).

Another embodiment expands to a multimodal approach that supports both stroke detection and continuous monitoring. Instead of training components in isolation, all available data sources are collected and trained in a single, end-to-end AI/ML model leveraging state-of-the-art transformer architectures and foundation models. This unified approach enhances accuracy, real-time responsiveness, and the ability to track patient progress over time, marking a significant advancement in stroke care. In addition, or in other embodiments, the AI/ML model is included in the mobile app.

### IX. Expanding from FAST to BE FAST

Certain embodiments increase the sensitivity and specificity of acute stroke diagnosis by detecting balance abnormalities and/or eye (gaze) abnormalities. For example, the sensors discussed herein may be used to detect balance abnormalities associated with stroke by identifying truncal and appendicular ataxia. The truncal (postural) ataxia can be detected via passive monitoring of accelerometer data. Appendicular (limb) ataxia can be detected from active arm movements, as detailed herein. Example signal patterns an unsteady or tremulous arm associated with imbalance are shown in FIG. 10B and FIG. 10C.

Further, the video processing discussed herein may also be used to track a subject's eyes for abnormalities in gaze movements. For example, a gaze tracking component may detect partial and sustained gaze deviation.

### X. Example Embodiments

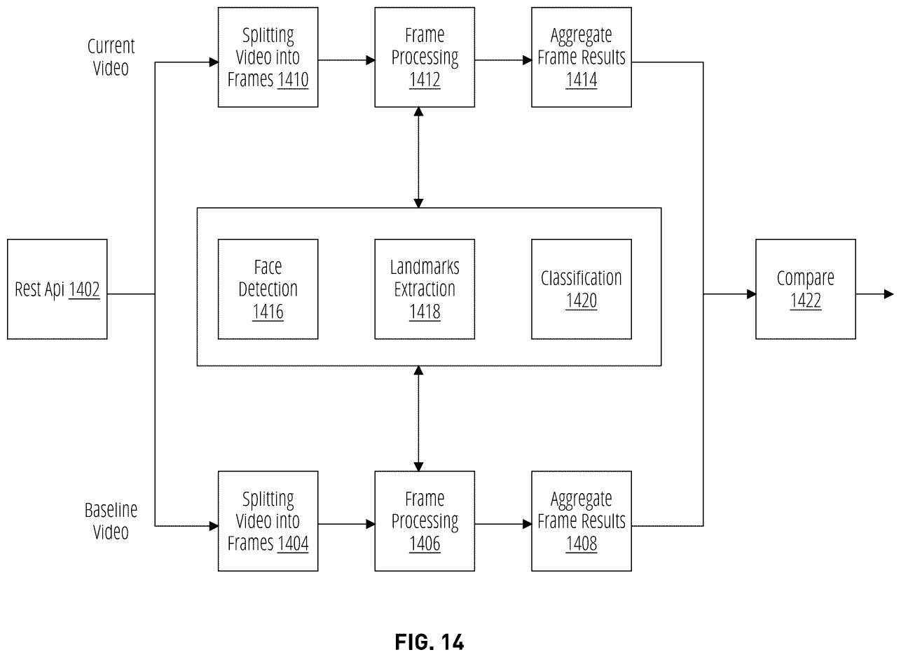

FIG. 14 illustrates an example of a FAST AI online inference pipeline wherein a current video and baseline video may be compared against each other according to one embodiment. The representational state transfer application programming interface (rest api 1402) may provide two videos pipelines, one for a baseline video and one for a current video. The current video may be split into frames 1410. Each frame may then be processed 1412 to, for example, detect a face 1416, extract landmark points 1418, and classify features 1420. The frame results of the current video may then be aggregated 1414 together. The baseline video may be split into frames 1404. Each frame may then be processed 1406 to, for example, detect a face 1416, extract landmark points 1418, and classify features 1420. The frame results of the baseline video may then be aggregated 1414 together. The aggregated video results of the current video 1414 may be compared 1422 to the aggregated video results of the baseline video 1408 to analyze differences thus possibly detecting an occurrence of a stroke.

In some examples, a rest api 1402 may be a set of rules and conventions that allow different software applications to communicate and interact with each other over the internet. It may be based on the principles of the REST architectural style, which emphasizes a stateless, client-server communication mode. API endpoints may provide a standardized way for clients to access and manipulate the resources offered by the server. By following the principles of REST, such as statelessness, uniform interface, and scalability, REST APIs may provide a flexible and scalable approach to building web services that can be easily consumed by various clients, including web browsers, mobile applications, and other software systems.

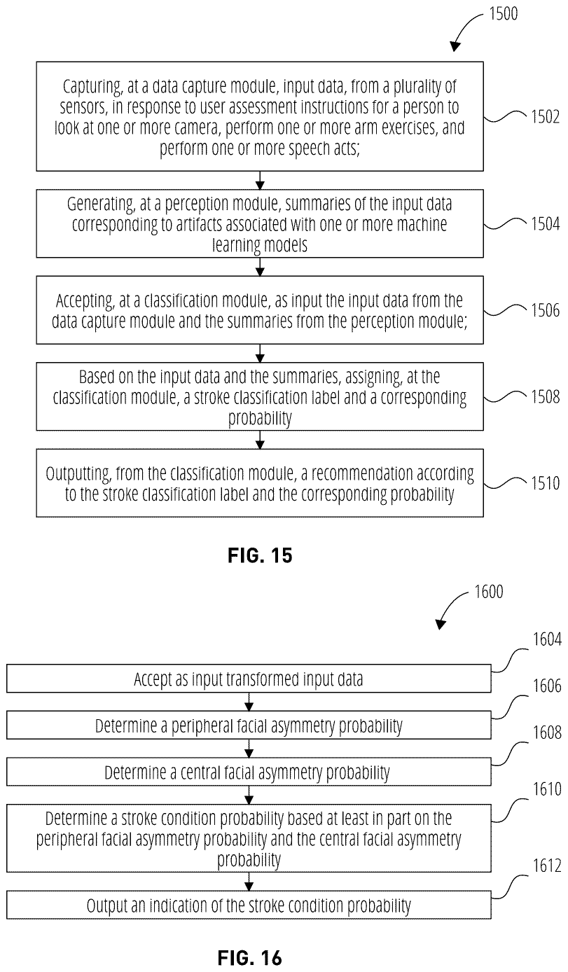

FIG. 15 illustrates a flowchart of a method 1500 for stroke detection, according to embodiments herein. The illustrated method 1500 includes capturing 1502, at a data capture module, input data, from a plurality of sensors, in response to user assessment instructions for a person to look at one or more camera, perform one or more arm exercises, and perform one or more speech acts. The method 1500 further includes generating 1504, at a perception module, summaries of the input data corresponding to artifacts associated with one or more machine learning models. The method 1500 further includes accepting 1506, at a classification module, as input the input data from the data capture module and the summaries from the perception module. The method 1500 further includes, based on the input data and the summaries, assigning 1508, at the classification module, a stroke classification label and a corresponding probability. The method 1500 further includes outputting 1510, from the classification module, a recommendation according to the stroke classification label and the corresponding probability.

In some embodiments, the method 1500 further comprises an instruction module for providing the user assessment instructions for the person who is experiencing a stroke, suspected of experiencing the stroke, or has experienced the stroke. In some such embodiments, the instruction module further instructs the person to sequentially look at the one or more camera, perform the one or more arm exercises, and perform the one or more speech acts. In other embodiments, the instruction module further instructs the person to perform two or more of the user assessment instructions in parallel. In certain embodiments, the instruction module outputs the user assessment instructions as text for a user to read or as synthesized speech.

In some embodiments, the method 1500 further comprises receiving, at the data capture module, the input data from the one or more camera positioned to capture video of a face of the person, and one or more audio capture device configured to record a voice of the person. In some such embodiments, the one or more camera provides at least one of color video and depth data, and the one or more camera may generate arm data corresponding to the one or more arm exercises. In some such embodiments, the data capture module further receives the input data from one or more motion sensor comprising at least one of an accelerometer, a gyroscope, and a magnetometer. The one or more motion sensor may generate arm data corresponding to the one or more arm exercises.

In some embodiments of the method 1500, the artifacts comprise one or more of a pose of a face, location points for the face, a facial asymmetry, a unilateral change of facial movement, an acceleration profile of an arm, an angular velocity of the arm, a speech summary comprising MFCC, a balance profile, and a gaze profile.

In some embodiments of the method 1500, the perception module comprises a face perception module for summarizing captured visual data and depth data from the one or more camera to define a position, a size, and an orientation of a face of the person along with locations of facial landmarks. In some such embodiments, the face perception module includes: a face detector for outputting bounding boxes corresponding to a largest detected face in a sequence of video frames; a facial landmark detector for processing video data corresponding to the bounding boxes to determine the locations of the facial landmarks; and a feature generator for determining a set of facial feature vectors from the facial landmarks for each of the sequence of video frames. In certain such embodiments, the facial landmarks are selected from a group comprising a left eye, a right eye, a left eyebrow, a right eyebrow, a forehead oval, a nose midline, a nose horizontal line, a right NLF, a left NLF, a right cheek, a left cheek, a lip inner circle, and a lip outer circle. Certain such embodiments further comprise using at least 90 location points to define the facial landmarks. In certain such embodiments, the classification module comprises a facial asymmetry submodule for determining a presence of facial asymmetry based on the set of facial feature vectors. In certain such embodiments, the facial asymmetry submodule uses a LDA model to determine the presence of the facial asymmetry. In certain such embodiments, the classification module further comprises a lateral analysis submodule for: measuring movement of a left side of the face of the person and a right side of the face of the person over a period of time; determining an affected side of the face as one of the left side of the face or the right side of the face has less movement over the period of time; and associating the affected side with the presence of the facial asymmetry. In certain such embodiments, for at least one of the face facial asymmetry submodule and a lateral analysis submodule, inference is performed using subsets of the sequence of video frames using a recurrent neural network or using a transformer or attention based architecture.

In certain embodiments of the method 1500, the face perception module accepts as input a video V that is split into frames F_{1, . . . , N}. Each frame Fᵢ may then processed by the face detector that outputs bounding boxes b_{1, . . . , M}_{ᵢ}, where Mᵢ is the number of faces detected in frame Fᵢ. The largest detected face in a frame may be found by applying non-maximal suppression based on the bounding box area such that Bᵢ=argmax({area(bᵢ)|bᵢ∈b_{1, . . . , M}_{ᵢ}}). As a result, there may be N bounding boxes denoted as B_{1, . . . , N}. Each bounding box is then passed through the facial landmark detector 314 resulting in a set Lᵢ={l_{i,1}, l_{i,2}, . . . , l_{i,K}} where l_{i,j}∈[0; 1]² is a 2D location with normalized coordinates between 0 and 1 with respect to Bᵢ and K is the number of detected facial landmark points in frame Fᵢ.

In some such embodiments, the facial landmark detector may be trained to extract a standard 68 key points that are widely used by the machine learning community. See, for example, Hohman, Marc H., et al. “Determining the threshold for asymmetry detection in facial expressions,” The Laryngoscope 124.4 (2014): 860-865. In other embodiments, however, the facial landmark detector 314 may be trained on a custom set of facial landmark points that has been identified by stroke specialists. The features generator may be configured to determine a set of facial feature vectors from the facial landmarks for each of the sequence of video frames. In some cases, directly processing the coordinates of the detected landmark points may yield a classifier with poor generalization capabilities as it may be sensitive to the location and orientation of the face in the image. To reduce or avoid these issues, the facial landmark points may be converted into a set of distances Dᵢ={L₂(l_{i,j}, l_{i,K})|l_{i,j}, l_{i,k}∈Lᵢ, i≠j} with cardinality

$$\vert {D}_{i} \vert = \frac{K * ( K - 1 )}{2}$$

and then a dimensionality reduction may be performed using PCA to obtain a final feature vector xᵢ^{face}∈ [symbol] for every video frame Fᵢ, where q is the target dimensionality for the PCA step. In some example embodiments, q=100 may be sufficient to explain more than 99% of the variance in Dᵢ for K=68.

In some such embodiments, the classification module, which may include or may be referred to as a facial asymmetry submodule, determines a presence of facial asymmetry based on the set of facial feature vectors. To do so, the classification module may use a classifier f_{asymmetry} that takes as an input xᵢ^{face} and outputs ŷᵢ^{face}=p(y_{asymmetry}=1|x=xᵢ^{face})=f_{asymmetry}(xᵢ^{face}), where y_{asymmetry}∈{0, 1} may indicate the presence of facial asymmetry. After extensive model comparison, the inventors of the present application determined that a LDA is well suited for this classification task. Processing every frame Fᵢ, i∈{1, . . . , N} in the video may result in N predictions

$${\hat{y}}_{1 , ⋯ , N}^{face}$$

that may be aggregated using a KDE to determine a mean predicted probability of asymmetry as well as an uncertainty of the estimate. In addition, certain embodiments include a lateral analysis submodule to perform a lateral analysis of observed face movements to identify which side of the face is likely affected. The analysis may be based on measuring the total movement of the left and right sides of the face and determining which side has moved less throughout the observed video. In particular, the set of normalized facial landmark points Lᵢ={l_{i,1}, l_{i,2}, . . . , l_{i,K}} may be split into subsets L_{i,left} and L_{i,right} including the facial landmark points that belong to the left and right side of the face, respectively, detected at video frame Fᵢ. Any points along the central vertical line of the face are included in both sets. The total displacement of facial landmark points on each side of the face may be estimated as d_{i,left}=Σₗ_{_{i,j}}_{∈L}_{_{i,left}} L₂(l_{i,j}, e_{i,left}) and d_{i,left}=Σₗ_{_{i,j}}_{∈L}_{_{i,right}} L₂(l_{i,j}, e_{i,right}), where e_{i,left} and e_{i,right} denote the locations of the center of the left eye and the right eye, respectively, in frame Fᵢ, and L₂ denotes the Euclidean norm. Processing the sequence of video frames results in the sequences d_{1,left}, d_{2,left}, . . . , d_{N,left} and d_{1,right}, d_{2,right}, . . . , d_{N,right} whose variances σ²_{left} and σ²_{right} indicate how much the left and right side of the face has moved throughout the video. The side with the lower variance is predicted to be the affected side.

In some embodiments of the method 1500, the perception module comprises an arm perception module for: resampling multi-dimensional acceleration data, multi-dimensional angular velocity data, and multi-dimensional magnetic field direction data to generate resampled signals comprising an equal sampling frequency and an equal length; truncating the resampled signals to generate truncated signals by removing transitionary artifacts during at least one of a beginning of a test and an end of the test; normalizing magnitudes of the truncated signals to generate normalized signals to account for at least one of different grasps and different sensor orientations; filtering the normalized signals to generate filtered signals by removing noise; and aggregating the filtered signals into an arm motion feature vector. In some such embodiments, the classification module further determines a presence of arm weakness in one of a left arm or a right arm of the person based on the arm motion feature vector. Certain such embodiments, further comprise using, at the classification module, a LR model to determine the presence of the arm weakness.

In some embodiments of the method 1500, the perception module comprises a speech perception module for: dividing a voice recording into audio subsegments corresponding to respectively pronounced words by the person; resampling the audio subsegments to a target sampling audio frequency to generate resampled audio subsegments; applying a Mel transformation to calculate a MFCC matrix for each of the resampled audio subsegments; and processing and concatenate each MFCC matrix to generate a speech feature vector. In some such embodiments, the classification module determines a presence of slurred speech by the person based on the speech feature vector. In certain such embodiments, the classification module uses an RR model to determine the presence of the slurred speech.

In some embodiments of the method 1500, the classification module merges predictions of facial asymmetry, arm weakness, and slurred speech to determine the stroke classification label as healthy or affected and the corresponding probability based on a connected neural network model with two layers. In some such embodiments, the classification module further comprises merging predictions of one or more of truncal ataxia, appendicular ataxia, and gaze tracking to determine the stroke classification label and the corresponding probability.

FIG. 16 illustrates a flowchart of a method 1600 for stroke detection, according to embodiments herein. The illustrated method 1600 includes accepting 1602 as input transformed input data. The method 1600 also includes an AI/ML model for determining 1604 a peripheral facial asymmetry probability, determining 1606 a central facial asymmetry probability, and determining 1608 a stroke condition probability based at least in part on the peripheral facial asymmetry probability and the central facial asymmetry probability. The method 1600 further includes outputting 1610 an indication of the stroke condition probability.

In certain embodiments of the method, the peripheral patterns of facial asymmetry are associated in a training data set with both an upper facial muscle weakness and a lower facial muscle weakness, and the central patterns of facial asymmetry are associated in the data set only with the lower facial muscle weakness. In certain such embodiments, the peripheral patterns of facial asymmetry are associated in the data set with Bell's palsy symptoms, and the central patterns of facial asymmetry are associated in the data set with the stroke symptoms (e.g., associated by neurologists' annotations).

In certain embodiments, the method 1600 further includes generating asymmetry indicia of the peripheral facial asymmetry probability and the central facial asymmetry probability. The method 1600 may further include generating lateral indicia of a left side face asymmetry or a right side face asymmetry.

In certain embodiments of the method 1600, speech data in the data set used to train the AI/ML model comprises lip-to-text data associated (e.g., by neurologists' annotations) with the stroke symptoms. The AI/ML model is further configured to determine a slurred speech probability based on a lip movement video. In certain such embodiments, the slurred speech probability is not dependent on a language spoken by a person (e.g., patient) while the lip movement video is captured. The AI/ML model may comprise a transformer lip-to-text model architecture, as described herein. In certain embodiments, the lip-to-text data comprises first language (e.g., English) data used to train the AI/ML model, and the lip-to-text data may further comprise second language data and third language data used to train the AI/ML model.

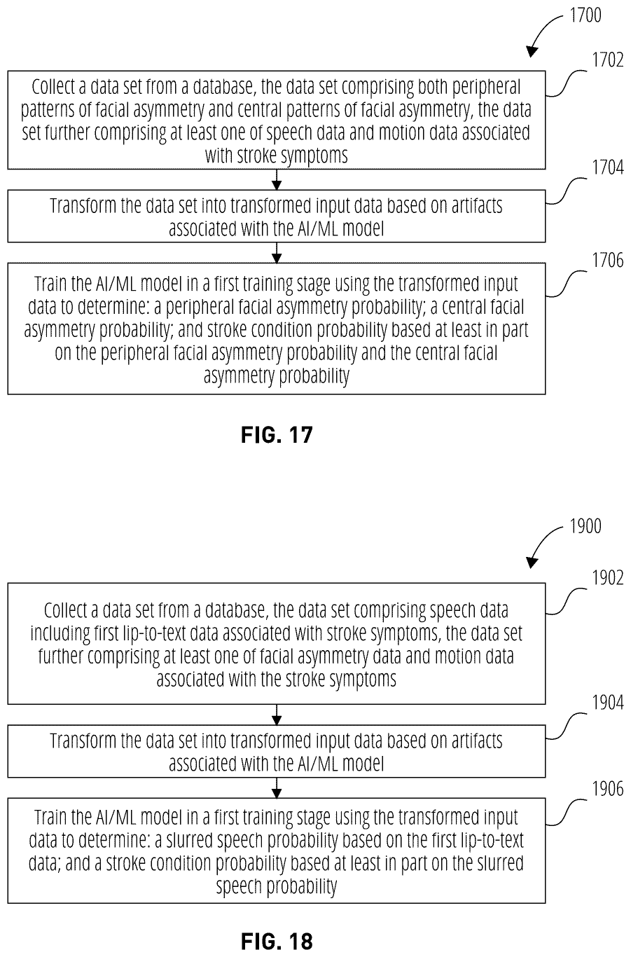

FIG. 17 illustrates a flowchart of a method 1700 for training an AI/ML model for stroke detection, according to embodiments herein. The method 1700 includes collecting 1702 a data set from a database. The data set comprises both peripheral patterns of facial asymmetry and central patterns of facial asymmetry. The data set further comprises at least one of speech data and motion data associated with stroke symptoms (e.g., associated by neurologists' annotations). The method 1700 further includes transforming 1704 the data set into transformed input data based on artifacts associated with the AI/ML model. The method 1700 further includes training 1706 the AI/ML model in a first training stage using the transformed input data to determine: a peripheral facial asymmetry probability; a central facial asymmetry probability; and a stroke condition probability based at least in part on the peripheral facial asymmetry probability and the central facial asymmetry probability.

In certain embodiments of the method 1700, the peripheral patterns of facial asymmetry are associated in the data set with both an upper facial muscle weakness and a lower facial muscle weakness, and the central patterns of facial asymmetry are associated in the data set only with the lower facial muscle weakness. In certain such embodiments, the peripheral patterns of facial asymmetry are associated in the data set with Bell's palsy symptoms, and the central patterns of facial asymmetry are associated in the data set with the stroke symptoms.

In certain embodiments of the method 1700, the speech data in the data set used to train the AI/ML model comprises first lip-to-text data associated with the stroke symptoms. In certain such embodiments, the method 1700 further includes training the AI/ML model in a second training stage to determine a slurred speech probability based on the first lip-to-text data, wherein the first lip-to-text data comprises a first language. The speech data in the data set used to train the AI/ML model may further comprise second lip-to-text data comprising a second language and a third language associated with the stroke symptoms, and the method 1700 may further comprise training the AI/ML model in a third training stage based on the second lip-to-text data to determine the slurred speech probability.

FIG. 18 illustrates a flowchart of a method 1800 for training an AI/ML model for stroke detection, according to embodiments herein. The method 1800 includes collecting 1802 a data set from a database. The data set comprises speech data including first lip-to-text data associated with stroke symptoms (e.g., associated by neurologists' annotations). The data set further comprises at least one of facial asymmetry data and motion data associated with the stroke symptoms. The method 1800 further includes transforming 1804 the data set into transformed input data based on artifacts associated with the AI/ML model. The method 1800 further includes training 1806 the AI/ML model in a first training stage using the transformed input data to determine: a slurred speech probability based on the first lip-to-text data; and a stroke condition probability based at least in part on the slurred speech probability.

In certain embodiments of the method 1800, the first lip-to-text data comprises a first language (e.g., English), and the speech data in the data set used to train the AI/ML model further comprises second lip-to-text data associated with the stroke symptoms. The second lip-to-text data comprising a second language (e.g., Mandarin Chinese) and a third language (e.g., Russian). The method 1800 may further include training the AI/ML model in a second training stage based on the second lip-to-text data to determine the slurred speech probability.

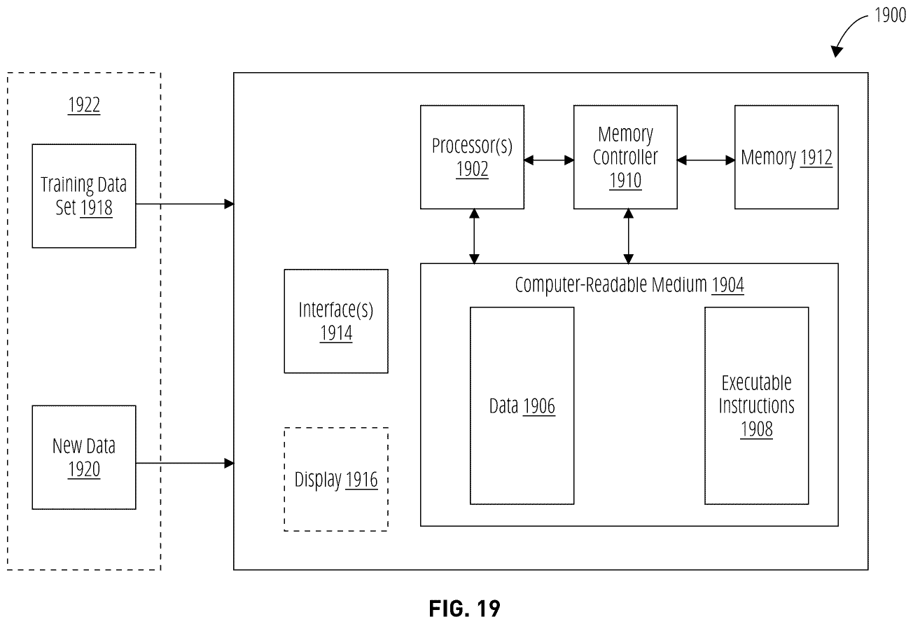

FIG. 19 is a schematic illustration of a computing system arranged in accordance with examples of the present disclosure. The computing system 1900 may be used to implement one or more machine learning models, such as the machine learning models described in FIG. 1 to FIG. 14.

The computer-readable medium 1904 may be accessible to the processor(s) 1902. The computer-readable medium 1904 may be encoded with executable instructions 1908. The executable instructions 1908 may include executable instructions for implementing a machine learning model to, for example, stroke detection. The executable instructions 1908 may be executed by the processor(s) 1902. In some examples, the Executable instructions 1908 may also include instructions for generating or processing training data sets and/or training a machine learning model. Alternatively or additionally, in some examples, the machine learning model, or a portion thereof, may be implemented in hardware included with the computer-readable medium 1904 and/or processor(s) 1902, for example, application-specific integrated circuits (ASICs) and/or field programmable gate arrays (FPGA).

The computer-readable medium 1904 may store data 1906. In some examples, the data 1906 may include one or more training data sets, such as training data set 1918. The training data may be based on a selected application. For example, the training data set 1918 may include one or more sequences of images, one or more audio files, and/or one or more motion data files. In some examples, training data set 1918 may be received from another computing system (e.g., a data acquisition module 1922, a cloud computing system). In other examples, the training data set 1918 may be generated by the computing system 1900. In some examples, the training data sets may be used to train one or more machine learning models. In some examples, the data 1906 may include data used in a machine learning model (e.g., weights, connections between nodes). In some examples, the data 1906 may include other data, such as new data 1920. The new data 1920 may include one or more image sequences, audio files, and/or motion data files not included in the training data set 1918. In some examples, the new data may be analyzed by a trained machine learning model to detect a stroke. In some examples, the data 1906 may include outputs, as described herein, generated by one or more machine learning models implemented by the computing system 1900. The computer-readable medium 1904 may be implemented using any medium, including non-transitory computer readable media. Examples include memory, random access memory (RAM), read only memory (ROM), volatile or non-volatile memory, hard drive, solid state drives, or other storage. While a single medium is shown in FIG. 19, multiple media may be used to implement computer-readable medium 1904.

In some examples, the processor(s) 1902 may be implemented using one or more central processing units (CPUs), graphical processing units (GPUs), ASICS, FPGAs, or other processor circuitry. In some examples, the processor(s) 1902 may execute some or all of the executable instructions 1908. In some examples, the processor(s) 1902 may be in communication with a memory 1912 via a memory controller 1910. In some examples, the memory 1912 may be volatile memory, such as dynamic random-access memory (DRAM). The memory 1912 may provide information to and/or receive information from the processor(s) 1902 and/or computer-readable medium 1904 via the memory controller 1910 in some examples. While a single memory 1912 and a single memory controller 1910 are shown, any number may be used. In some examples, the memory controller 1910 may be integrated with the processor(s) 1902.

In some examples, the interface(s) 1914 may provide a communication interface to another device (e.g., the data acquisition module 1922), a user, and/or a network (e.g., LAN, WAN, Internet). The interface(s) 1914 may be implemented using a wired and/or wireless interface (e.g., Wi-Fi, BlueTooth, HDMI, USB, etc.). In some examples, the interface(s) 1914 may include user interface components which may receive inputs from a use. Examples of user interface components include a keyboard, a mouse, a touch pad, a touch screen, and a microphone. In some examples, the interface(s) 1914 may communicate information, which may include user inputs, data 1906, training data set 1918, and/or new data 1920, between external devices (e.g., the data acquisition module 1922) and one or more components of the computing system 1900 (e.g., processor(s) 1902 and computer-readable medium 1904).

In some examples, the computing system 1900 may be in communication with a display 1916 that is a separate component (e.g., using a wired and/or wireless connection) or the display 1916 may be integrated with the computing system. In some examples, the display 1916 may display data 1906 such as outputs generated by one or more machine learning models implemented by the computing system 1900. Any number or variety of displays may be present, including one or more LED, LCD, plasma, or other display devices.

In some examples, the training data set 1918 and/or new data 1920 may be provided to the computing system 1900 via the interface(s) 1914. Optionally, in some examples, some or all of the training data set 1918 and/or new data 1920 may be provided to the computing system 1900 by one or more sensors of the data acquisition module 1922, such as the data acquisition devices 104 shown in FIG. 1 or the data acquisition module 206 shown in FIG. 2. In some examples, the data acquisition module 1922 may include a color camera or video camera, an audio capture device, motion sensors (e.g., accelerometers), or a combination thereof.

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A stroke detection system comprising:
one or more processors; and
a memory storing executable instructions that, when executed by the one or more processors, implement:
a data capture module to capture input data from a plurality of sensors, in response to user assessment instructions for a person to look at one or more camera, perform one or more arm exercises, and perform one or more speech acts;
a perception module to transform the input data into transformed input data based on artifacts associated with an artificial intelligence or machine learning (AI/ML) model;
a classification module comprising the AI/ML model trained using a data set comprising both peripheral patterns of facial asymmetry and central patterns of facial asymmetry, the data set further comprising at least one of speech data and motion data associated with stroke symptoms, the classification module configured to:
accept as input the transformed input data from the perception module;
based on the transformed input data:
determine a peripheral facial asymmetry probability;
determine a central facial asymmetry probability; and
determine a stroke condition probability based at least in part on the peripheral facial asymmetry probability and the central facial asymmetry probability; and
output an indication of the stroke condition probability.

2. The stroke detection system of claim 1, wherein the peripheral patterns of facial asymmetry are associated in the data set with both an upper facial muscle weakness and a lower facial muscle weakness, and wherein the central patterns of facial asymmetry are associated in the data set only with the lower facial muscle weakness.

3. The stroke detection system of claim 2, wherein the peripheral patterns of facial asymmetry are associated in the data set with Bell's palsy symptoms, and wherein the central patterns of facial asymmetry are associated in the data set with the stroke symptoms.

4. The stroke detection system of claim 1, wherein the executable instructions are further configured to, when executed by the one or more processors, generate asymmetry indicia of the peripheral facial asymmetry probability and the central facial asymmetry probability.

5. The stroke detection system of claim 4, wherein the executable instructions are further configured to, when executed by the one or more processors, generate lateral indicia of a left side face asymmetry or a right side face asymmetry.

6. The stroke detection system of claim 1, wherein the speech data in the data set used to train the AI/ML model comprises lip-to-text data associated with the stroke symptoms.

7. The stroke detection system of claim 6, wherein the classification module comprising the AI/ML model is further configured to determine a slurred speech probability based on lip movement video obtained by the data capture module.

8. The stroke detection system of claim 7, wherein the slurred speech probability is not dependent on a language spoken by the person while the data capture module captures the lip movement video.

9. The stroke detection system of claim 6, wherein the AI/ML model comprises a transformer lip-to-text model architecture.

10. The stroke detection system of claim 6, wherein the lip-to-text data comprises first language data used to train the AI/ML model.

11. The stroke detection system of claim 10, wherein the lip-to-text data further comprises second language data and third language data used to train the AI/ML model.

12. A computer-implemented method of training an artificial intelligence or machine learning (AI/ML) model for stroke detection, comprising:
collecting a data set from a database, the data set comprising both peripheral patterns of facial asymmetry and central patterns of facial asymmetry, the data set further comprising at least one of speech data and motion data associated with stroke symptoms;
transforming the data set into transformed input data based on artifacts associated with the AI/ML model; and
training the AI/ML model in a first training stage using the transformed input data to:
determine a peripheral facial asymmetry probability;
determine a central facial asymmetry probability; and
determine a stroke condition probability based at least in part on the peripheral facial asymmetry probability and the central facial asymmetry probability.

13. The computer-implemented method of claim 12, wherein the peripheral patterns of facial asymmetry are associated in the data set with both an upper facial muscle weakness and a lower facial muscle weakness, and wherein the central patterns of facial asymmetry are associated in the data set only with the lower facial muscle weakness.

14. The computer-implemented method of claim 13, wherein the peripheral patterns of facial asymmetry are associated in the data set with Bell's palsy symptoms, and wherein the central patterns of facial asymmetry are associated in the data set with the stroke symptoms.

15. The computer-implemented method of claim 12, wherein the speech data in the data set used to train the AI/ML model comprises first lip-to-text data associated with the stroke symptoms.

16. The computer-implemented method of claim 15, further comprising training the AI/ML model in a second training stage to determine a slurred speech probability based on the first lip-to-text data, wherein the first lip-to-text data comprises a first language.

17. The computer-implemented method of claim 16, wherein the speech data in the data set used to train the AI/ML model further comprises second lip-to-text data comprising a second language and a third language associated with the stroke symptoms, and wherein the computer-implemented method further comprises training the AI/ML model in a third training stage based on the second lip-to-text data to determine the slurred speech probability.

18. A computer-implemented method of training an artificial intelligence or machine learning (AI/ML) model for stroke detection, comprising:
collecting a data set from a database, the data set comprising speech data including first lip-to-text data associated with stroke symptoms, the data set further comprising at least one of facial asymmetry data and motion data associated with the stroke symptoms;
transforming the data set into transformed input data based on artifacts associated with the AI/ML model; and
training the AI/ML model in a first training stage using the transformed input data to:
determine a slurred speech probability based on the first lip-to-text data; and
determine a stroke condition probability based at least in part on the slurred speech probability.

19. The computer-implemented method of claim 18, wherein the first lip-to-text data comprise a first language, and wherein the speech data in the data set used to train the AI/ML model further comprises second lip-to-text data associated with the stroke symptoms, the second lip-to-text data comprising a second language and a third language.

20. The computer-implemented method of claim 19, further comprising training the AI/ML model in a second training stage based on the second lip-to-text data to determine the slurred speech probability.
